(19) United States
(12) Patent Application Publication
(10) Pub. No.: US 2025/0232197 A1
(43) Pub. Date: Jul. 17, 2025

(54) METHODS, SYSTEM, AND APPARATUS FOR INFERENCE USING PROBABILITY INFORMATION

(71) Applicant: Huawei Technologies Co., Ltd., Shenzhen (CN)

(72) Inventors: Huazi Zhang, Hangzhou (CN); Yiqun Ge, Ottawa (CA); Jianglei Ma, Ottawa (CA); Wen Tong, Ottawa (CA)

(21) Appl. No.: 19/076,861

(22) Filed: Mar. 11, 2025

Related U.S. Application Data
(63) Continuation of application No. PCT/CN2022/118702, filed on Sep. 14, 2022.

(51) Int. Cl. G06N 5/046; G06N 7/01

(52) U.S. Cl. CPC G06N 5/046; G06N 7/01

(57) ABSTRACT

Input data for inference processes are often highly correlated and interdependent. These correlations provide an inherent redundancy in the input data which can be used to refine inference results and thus improve inference performance. In some embodiments, probability information is used to refine results from an inference process. The probability information indicates, for each of a plurality of potential results obtainable from the inference process, a probability of obtaining the respective potential result and another potential result from the plurality of potential results.

### CROSS-REFERENCE TO RELATED APPLICATION

This application is a continuation of International Application No. PCT/CN2022/118702, filed on Sep. 14, 2022, the disclosure of which is hereby incorporated by reference in its entirety.

### TECHNICAL FIELD

This application relates to inference and, in particular, to inference using probability information.

### BACKGROUND

Wireless communication systems of the future, such as sixth generation or “6G” wireless communications, are expected to trend towards ever-diversified application scenarios, including using artificial intelligence (AI), such as machine-learning (ML), and sensing to provide services for large numbers of devices.

One common application of machine learning is performing inference to extract insights from data. In the context of wireless communication networks, a machine learning process, such as a deep neural network (DNN), may be trained to perform inference using data from devices in the network. The machine learning process may be deployed in, for example, a data center which is remote from the devices providing the data, which means that large amounts of data may need to be transferred over the network from the devices to the machine learning process. As wireless connections may not provide sufficient bandwidth and stability to transfer data to the machine learning process, this data transfer may only be feasible when the devices are connected to the network by wired or optical fiber connections which can provide wideband and stable connections.

### SUMMARY

In next generation networks, inference may be carried out jointly by the network and devices in the network, rather than only at a centralized data center. An inference job may be distributed to multiple devices, such that each device performs one or more tasks as part of a distributed machine learning process. This can alleviate the computational load of each device compared to a situation where one device performs the entire inference job, whilst also reducing the amount of data that each device may need to communicate as part of the machine learning process (e.g., reducing the traffic load). Since the computation and traffic load of each device is decreased, lower-complexity devices, such as IoT devices, may be used to perform inference. This means that inference can be performed using low-cost hardware that may even be battery powered.

However, challenges can still arise as low-cost devices may be less reliable, in terms of both communication and computation. The low capability of individual devices can lead to poor inference performance in a real-time system that requests not only inference accuracy but also short latency. Many devices may be needed to work collaboratively to enhance the inference performance (e.g., to enhance accuracy and latency) and achieve the desired quality of service.

According to aspects of the present disclosure, inference results from a distributed inference process can be refined by exploiting correlations present in the data on which inference is performed. Input data for inference processes are often highly correlated and interdependent. These correlations provide an inherent redundancy in the input data which can be used to refine inference results and thus improve inference performance. This may improve the accuracy of inference results, for example. In addition, using these correlations can enable adapting inference to particular applications, environments and changes in environments.

In a first aspect, a method is provided. The method involves receiving, from a network device, an input for a component inference process that forms part of a distributed inference process representative of a machine learning process. The method also involves performing the component inference process on the input to obtain a first inference result. The method also involves transmitting, to the network device, a second inference result based on the first inference result and probability information. The probability information indicates, for each of a plurality of potential results obtainable from the component inference process, a probability of obtaining the respective potential result and another potential result from the plurality of potential results.

The machine learning process may comprise a classification process. The plurality of potential results may include a plurality of classes such that the probability information indicates, for each of the plurality of classes obtainable from the component inference process, a probability of obtaining the respective class and another class from the plurality of classes. The first inference result may include, for each class i in the plurality of classes, a respective first confidence c₁(i). The second inference result may include, for each class in the plurality of classes, a respective second confidence c₂(i).

The probability information may include, for each class in the plurality of classes, a respective conditional probability, P(i, j|j), of obtaining the respective class i and the other class j from the plurality of potential results given the other potential result j has been obtained from the component inference process. The method further involves determining the respective second confidence c₂(i) for a respective class i in the plurality of classes according to:

$${c}_{2} ( i ) = {c}_{1} ( i ) + {\sum }_{i} {c}_{1} ( j ) P ( i , j \vert j ) .$$

The machine learning process may include a regression process. The plurality of potential results may comprise a plurality of values of a parameter. The first inference result may include a first probability distribution P₁(xᵢ) of the parameter associated with first data i in the input. The second inference result may include a second probability distribution P₂(x₁) of the parameter associated with the first data i.

The probability information may include a joint probability P(xᵢ, xⱼ) of obtaining the first value xᵢ of the parameter and obtaining a second value xⱼ of the parameter. The method further comprises determining the second probability distribution according to

$${P}_{2} ( {x}_{i} ) = \int {P}_{1} ( {x}_{j} ) P ( {x}_{i} , {x}_{j} ) d {x}_{j} .$$

The probability information may include a conditional probability P (xᵢ|xⱼ) of obtaining a first value xᵢ of the parameter given a second value xⱼ of the parameter has been obtained. The method further comprises determining the second probability distribution according to:

$${P}_{2} ( {x}_{i} ) = \int {P}_{1} ( {x}_{j} ) P ( {x}_{i} \vert {x}_{j} ) d {x}_{j} .$$

The method may also involve receiving an indication of the probability information from the network device.

The method may also involve updating the probability information based on the first inference result or the second inference result.

The method may also involve one or more of: indicating the updated probability information to the network device, and indicating the updated probability information to an apparatus configured to perform inference as part of the distributed inference process.

An apparatus (e.g., an entity) configured to perform the aforementioned method is also provided. In yet another aspect, a memory (e.g., a non-transitory processor-readable medium) is provided. The memory contains instructions (e.g., processor-executable instructions) which, when executed by a processor of an apparatus, cause the apparatus to perform the method described above.

In a second aspect, a method performed by a network device is provided. The method includes transmitting, to each of a plurality of processing apparatuses, a respective first input in a plurality of first inputs. Each respective first input is for a component inference process as part of a distributed inference process representative of a machine learning process. The method also includes receiving, from the plurality of processing apparatuses, first inference results obtained based on probability information and the plurality of first inputs, in which the probability information indicates, for each of a plurality of potential results obtainable from the component inference process, a probability of obtaining the respective potential result and another potential result from the plurality of potential results.

The plurality of first inputs may include a plurality of second inputs and at least one redundant input. The method may further include encoding the plurality of second inputs to generate the at least one redundant input and decoding the first inference results to obtain second inference results.

The method may also involve receiving from at least one of the plurality of processing apparatuses, a respective update to the probability information based on the first inference result obtained from the component inference process.

The method may also involve indicating, to the plurality of processing apparatuses, the probability information by indicating a same probability information to each of the plurality of processing apparatuses.

The method may also involve indicating, to the plurality of processing apparatuses, the probability information by indicating, to at least one of the plurality of processing apparatuses, first probability information that is specific to the respective processing apparatus.

The plurality of potential results obtainable from the component inference process may be a first plurality of potential results. The method may also involve obtaining second probability information indicating, for each of a second plurality of potential results obtainable from the distributed inference process, a probability of obtaining the respective potential result and another potential result from the second plurality of potential results. The method may also involve, for each of the at least one of the plurality of processing apparatuses, selecting the first probability information from the second probability information based on the first plurality of potential results.

A network device configured to perform the aforementioned method is also provided. In yet another aspect, a memory (e.g., a non-transitory processor-readable medium) is provided. The memory contains instructions (e.g., processor-executable instructions) which, when executed by a processor of a network device, cause the network device to perform the method described above.

In a third aspect, a method performed by a network device is provided. The method involves transmitting, to each of a plurality of processing apparatuses, a respective first input in a plurality of first inputs. The respective first input is for a component inference process as part of a distributed inference process representative of a machine learning process. The method also includes receiving, from the plurality of processing apparatuses, first inference results based on the plurality of first inputs. The method also includes determining second inference results based on the first inference results and probability information, in which the probability information indicates, for each of a plurality of potential results obtainable from the component inference process, a probability of obtaining the respective potential result and another potential result from the plurality of potential results.

The plurality of first inputs may include a plurality of second inputs and at least one redundant input. The method may further include encoding the plurality of second inputs to generate the at least one redundant input and decoding the first inference results to obtain second inference results.

In a fourth aspect, a method is provided. The method includes performing an inference process on input data to obtain a first inference result. The method also includes determining a second inference result based on the first inference result and probability information. The probability information indicates, for each of a plurality of potential results obtainable from the inference process, a probability of obtaining the respective potential result and another potential result from the plurality of potential results.

In yet another aspect, a system is provided. The system comprises a first device configured to obtain a first inference result as a part of a distributed inference process representative of a machine learning process. The system further comprises a second device in communication with the first device. The second device is configured to obtain a second inference result as a part of the distributed inference process, and the second inference result is based on the first inference result and probability information. The probability information indicates, for each of a plurality of potential results obtainable from the inference process, a probability of obtaining the respective potential result and another potential result from the plurality of potential results.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 is a block diagram of an example system for implementing a coded inference process according to embodiments of the disclosure.

FIGS. 6 and 7 show the number of times each object in a plurality of objects appears in the same image as another object in two sets of images.

FIG. 8 shows the number of times different classes of objects appear in the same image for a set of images.

FIGS. 9 and 10 show correlation maps for classes of images in two datasets.

FIG. 11 is an illustration of a method according to embodiments of the disclosure.

FIGS. 12-15 show flowcharts of methods according to embodiments of the disclosure.

FIGS. 16 and 17 show the detection and classification of objects in images according to embodiments of the disclosure.

FIG. 18 shows object detection rates for distributed inference processes performed according to embodiments of the disclosure.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

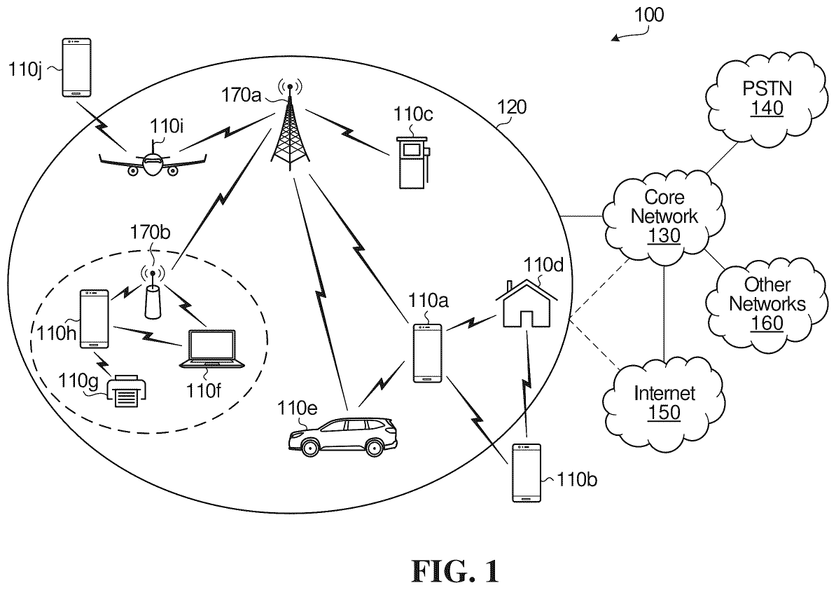

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

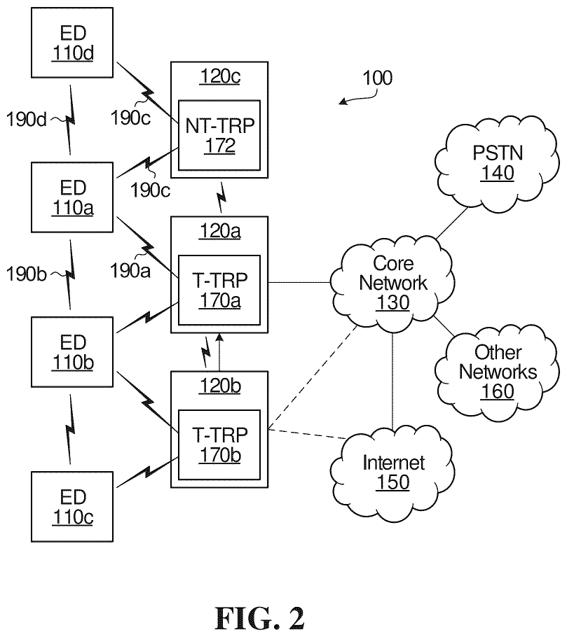

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

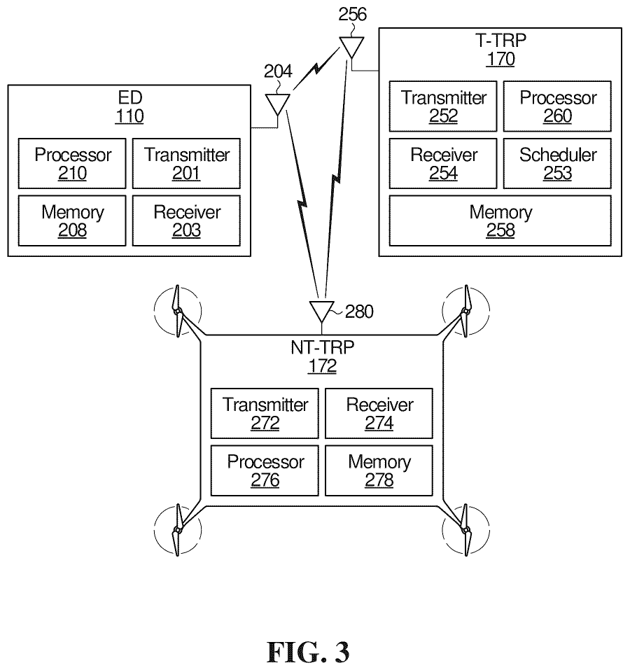

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

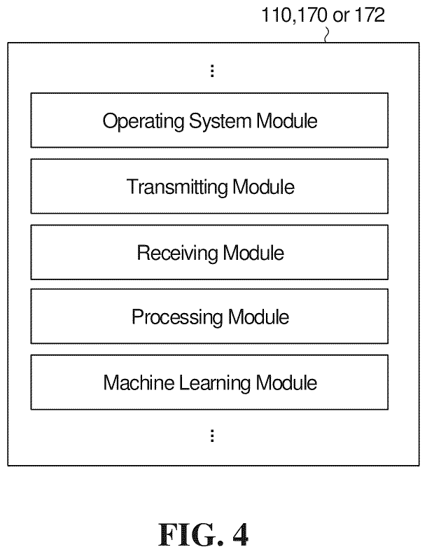

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Performing Inference

In situations in which a centralized machine learning process, such as a centralized DNN, performs inference using data from a distributed set of devices, the reliability of the machine learning process may be dependent on the quality, reliability, and latency of transmissions between the machine learning process and the devices.

This can be mitigated by performing inference locally relative to data sources. Thus, for example, the machine learning process could be deployed closer to the devices. However, machine learning processes can be computationally intensive. A DNN, for example, may have as many as 10-100 billion neurons. As such, it may be challenging to perform inference using a machine learning process on a single client device.

Instead, a machine learning process can be implemented using low-cost and low-power apparatus by distributing the machine learning process across a plurality of apparatus. In the context of wireless communication networks, distributed inference may be particularly advantageous since input data for inference processes is often collected by apparatus in access networks, such as electronic communication devices and TRPs. By distributing machine learning processing across a plurality of apparatus, the machine learning process can be implemented in, or near to, the access network, reducing the risk of input data for the machine learning process being lost or delayed.

However, when a machine learning process is distributed across multiple apparatus, there is a risk of an apparatus not returning its result due to, for example, an error in computation or transmission. This risk can be mitigated by introducing redundancy such that a missing result can be recovered.

Coded inference is one way of introducing this redundancy. In coded inference, inputs to a distributed learning process are encoded to produce a redundant input. The inputs and the redundant input are processed by component inference processes (which may be the same or different) to produce inference results and a redundant result. The redundant result can be used to recover a lost inference result and/or to refine the inference results.

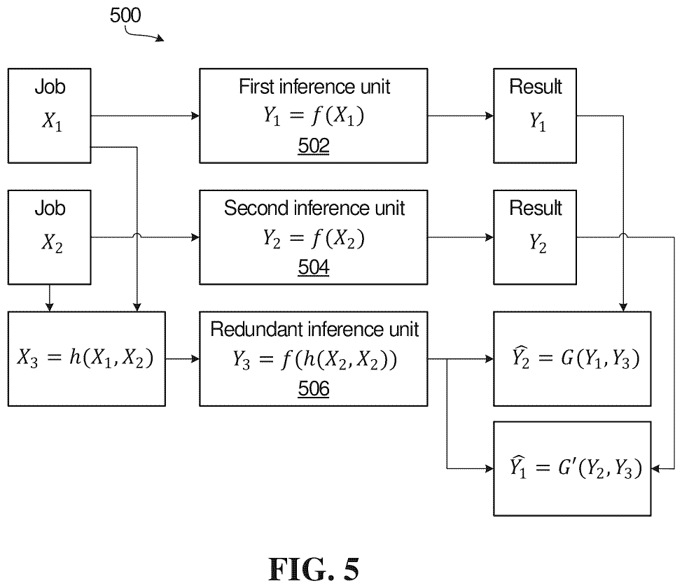

An example system 500 for implementing coded inference is shown in FIG. 5. The system includes a first inference unit 502 and a second inference unit 504. The first inference unit 502 is operable to perform a component inference process on a first input X₁ as part of the distributed inference process to obtain a first result Y₁=f(X₁). The second inference unit 504 is operable to perform a component inference process (e.g., the same component inference process) on a second input X₂ to obtain a second result Y₂=f(X₂) as part of the distributed inference process.

The system 500 further comprises a redundant inference unit 506, which is operable to receive a redundant input X₃=h(X₁,X₂) obtained by encoding the first and second inputs. The redundant inference unit 506 is operable to perform a component inference process on the redundant input in order to output a third result, Y₃=f(h(X₁,X₂)) which can be used to recover one of the first or second results.

The inference units 502-506 may be implemented at any processing apparatus. In some examples, the inference units 502-506 may be implemented at respective electronic devices (e.g., terminal devices, user equipments or internet of things devices). The electronic devices may be any suitable electronic devices, such as fixed cameras or mobile phones, in-vehicle sensors, etc.

The system 500 may further include an encoding unit and a decoding unit (not shown). The encoding unit encodes (e.g., processes) the inputs X₁, X₂ to generate the redundant input h(X₁, X₂). The decoding unit decodes the redundant inference result Y₃ with at least one of the first and second inference results Y₁, Y₂ to recover a missing result and/or refine the inference results Y₁, Y₂. In some examples, the encoding unit and the decoding unit may be a single unit (e.g., a combined encoder-decoder). The encoding unit and/or decoding unit may be implemented in a network device, such as a TRP, base station or access point, or another apparatus (e.g., an electronic device). The encoding unit and/or decoding unit may be implemented at one of the inference units 502-506.

In some examples, the redundant input is based on a linear combination of the inputs. The redundant inference unit 506 may be trained to provide a redundant result which is a linear combination of the inference results. This approach can enable distributed coded inference, but it can increase complexity at the redundant inference unit 506. In other implementations of coded inference, an AI/ML-invariant transformation may be imposed when generating the redundant input from the inputs. For example, the redundant input X₃ may include a concatenation of the inputs. Generating the redundant input in this manner avoids the need for additional training for the redundant inference unit 506, which means the same component inference process can be used at the first and second inference units 502-504 and the redundant inference unit 506 to process the inputs and the redundant inputs. This means that inference tasks can be deployed without time-consuming training, which means the deployment of inference tasks does not need to be done in a case-by-case manner. As inference applications become more specialized and diverse in the 6G era, it is expected that this will save significant time and resources for service providers.

Coded inference takes inspiration from error correction coding, which is also referred to herein as channel coding. This can be illustrated by considering a channel encoder that encodes an input binary sequence by adding some redundant bits. The redundant bits may be computed from and placed with the input binary sequence in a pre-defined method, which may generate some correlations between the redundant bits and input binary sequence within the codeword (the output of the channel encoder). When the codeword is decoded by a channel decoder, the channel decoder uses these correlations to recover the most likely binary sequence. This creates a coding gain which may be attributed to the correlations between the original input sequence and redundant bits.

In contrast to error correction coding, which typically deals with binary inputs, coded inference can use a wider variety of data as input, such as images, audio, video, or a point cloud. The outputs from a coded inference may be inference results such as for example, a class (also referred to herein as a label) and/or a quantity.

The inputs to a coded inference process may not follow the same classical statistical assumptions as error correction coding. In particular, the inputs to a coded inference process might not be independent and memoryless. Rather, in many applications the inputs for coded inference processes may be highly correlated and dependent.

Taking image classification as an example, some objects may be more likely to appear in a same image than others. For example, a zebra is more likely to appear in an image of a giraffe than an image of a whale. This is an example of spatial correlation within a dataset.

In other examples, inference results may be temporally correlated. Events in the real world are often causal in the sense that one event can lead to another. As a result, real world data often includes temporal correlations. An example of this is audio and video clips, in which the events and/or objects occurring in adjacent time frames may depend on one another.

Aspects of the present disclosure use correlations that are expected to be present in input data to improve inference performance. The correlations may be quantified in probability information, which indicates the probability of obtaining one inference result and another inference result. The probability may be a joint probability or a conditional probability. In embodiments of the present disclosure, an inference result obtained from an inference process, such as a machine learning process or a distributed inference process representative of a machine learning process, may be refined using probability information indicating the probability of obtaining both a particular inference result and another inference result.

By using the correlations that are expected to be present in input data to refine an inference result, inference performance can be increased. In particular embodiments, probability information may be used to refine inference results from a coded inference process, resulting in a process referred to as correlated coded inference. This allows for using two types of redundancies, both the redundancy inherent in the input data and redundancy generated through coded inference, to jointly improve the performance of the inference algorithm.

### Quantifying the Correlations in Probability Information

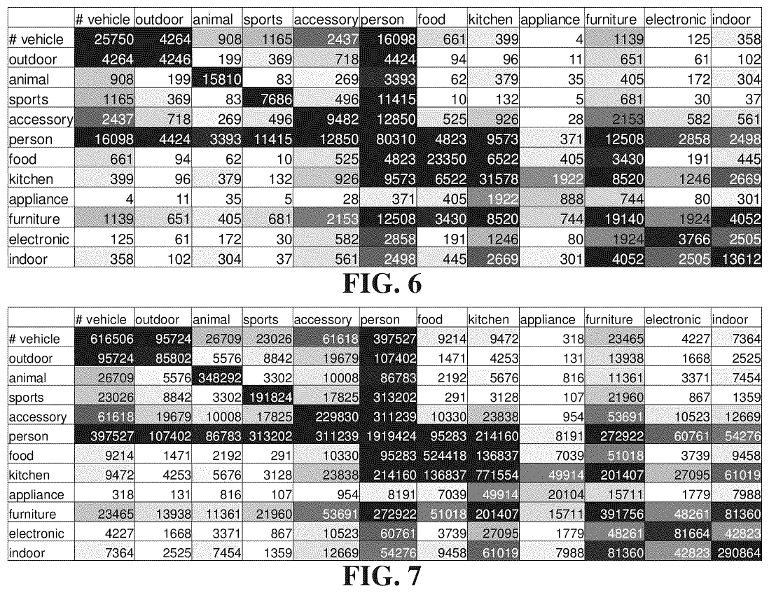

The nature of the probability information and methods for obtaining it may be described in more detail with reference to FIGS. 6-10, which illustrate examples of correlations that may arise in input data for inference processes. FIGS. 6-10 relate to the detection and identification of objects in images, also referred to as image classification. Image classification is used herein as an example of an inference process to which aspects of the disclosure may be applied. In general, aspects of the disclosure may be applied to any suitable inference process.

FIG. 6 is a table obtained using images in the COCO training dataset (COCO-train2017 dataset; Lin, Tsung-Yi, et al. “Microsoft coco: Common objects in context.” European conference on computer vision. Springer, Cham, 2014). FIG. 7 is a similar table for the COCO validation dataset (COCO-val2017 dataset; Lin, Tsung-Yi, et al. “Microsoft coco: Common objects in context.” European conference on computer vision. Springer, Cham, 2014). Objects in the images in the COCO datasets are labelled with one of 80 classes. The 80 classes are grouped into 12 superclasses. These 12 superclasses are listed along the first rows and columns of the tables shown in FIGS. 6 and 7.

The tables in FIGS. 6 and 7 show, for images in each respective COCO dataset, the number of times an object in a particular superclass is present in the same image as an object in another superclass. The cells of the table are shaded to reflect the strength of the correlation: the more darkly shaded a cell associated with a particular pair of superclasses, the more images as associated with both superclasses in the pair. Each of these tables form a correlation map that allows for visualizing the statistical resemblance between different datasets. Similar tables may be generated for any set of data with associated classes by, for each data (e.g., each image) in the set of data, increasing a counter associated with a group of (e.g., pair of) classes each time the group of classes are present in the same data.

The tables in FIGS. 6 and 7 show that some superclasses of objects are more likely to appear in the same images than others. For example, 4264 images in the training dataset (FIG. 6) have both outdoor objects and vehicles, whereas only 4 images in the training dataset (FIG. 6) have both appliances and vehicles. This illustrates that vehicles are more likely to appear in the same images as outdoor objects than in images containing an appliance.

As another example, 136,837 images in the validation dataset (FIG. 7) have both the food objects and kitchen objects, whereas only 291 images have both food objects and sports objects. This illustrates that food objects and kitchen objects are more likely to appear in the same images than food objects and sports objects.

Both tables also demonstrate that the number of images containing a person and an object from another superclass is high. This is illustrated by the darker shading along the row labelled person and indicates that the superclass “person” is highly correlated with all of the other superclasses. This is reflective of people (humans) being the center of the world observed by humans.

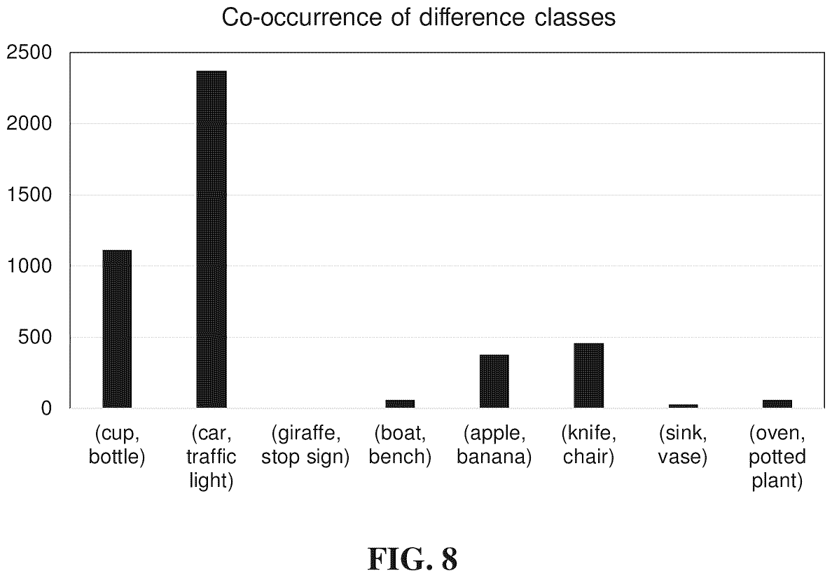

Similar correlations are also found in the 80 classes in the COCO dataset. This is illustrated in FIGS. 8-10. FIG. 8 shows the co-occurrence of a few pairs of classes for the COCO validation dataset. As shown in FIG. 8, cars and traffic lights appear together in over 2,000 images, whereas giraffes and stop signs appear together in a small number of images. This illustrates that cars and traffic lights are much more likely to appear in the same image than giraffes and stop signs.

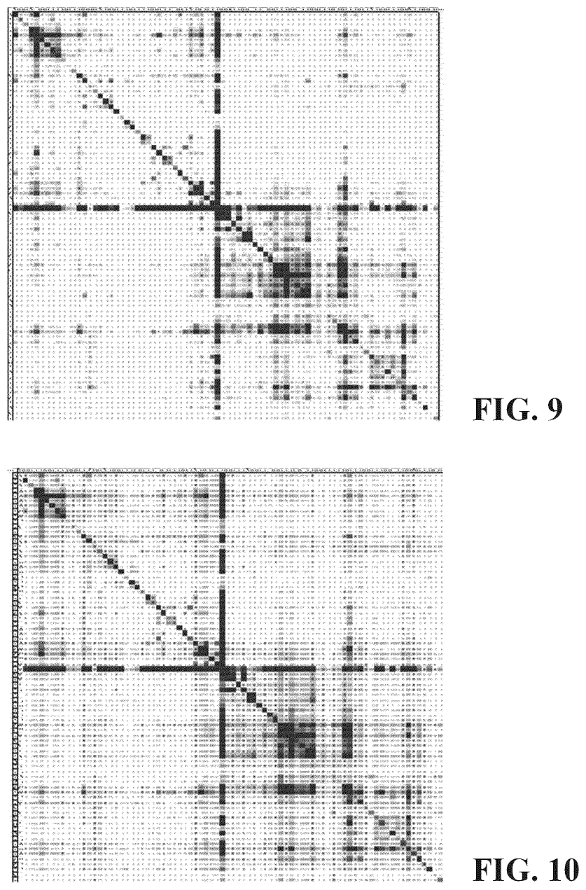

FIGS. 9 and 10 show maps illustrating the number of times an object in a respective class appears in the same image as an object in another respective class for all 80 classes in the COCO training dataset (FIG. 9) and the COCO validation dataset (FIG. 10). Each row and column is associated with a respective class such that each cell is associated with a pair of classes. The more darkly shaded a cell for a particular pair of classes, the larger the number of images containing objects in both classes. Although the training and validation datasets are independent, the same correlations are present in both images. As such, both datasets suggest that the same classes of objects are likely to appear in the same images.

According to embodiments of the disclosure, these correlations may be quantified in probability information. The probability information indicates, for each of the plurality of classes into which objects in the images in the COCO dataset can be classified, a probability of an object in the respective class and an object in another class from the plurality of classes being present in the same image.

In some examples, the probability information may include a set of conditional probabilities {P(i|j)} for i, j=1, . . . . N, in which each respective conditional probability P(i|j) is the probability of an object in class i appearing in a particular image given an object in class j appears in the image. The set of conditional probabilities may be determined by counting the number of times objects in each pair of classes appears in images a particular COCO dataset to obtain a respective co-appearance count A(i, j) for each pair. The co-appearance count may alternatively be referred to as a coincidence count, for example.

The conditional probability of an object in class i being present given an object in class j is present is obtained by normalizing the co-appearance count for the respective pair with respect to the total number of appearances of objects in class i. For example, the respective conditional probability P(i|j) of an object in class i being present, given an object in class j is present, may be determined according to:

$$P ( i \vert j ) = \frac{A ( i , j )}{{\sum }_{i = 1}^{i = N} A ( i , j )} . \qquad ( 1 )$$

In other examples, the probability information may include a set of joint probabilities {P(i, j)} for i=1, . . . . N and j=1, . . . . N, which includes, for each pair of classes i, j, the probability of objects in both classes appearing in a particular image P(i, j). The set of joint probabilities may be determined based on the co-appearance counts A(i, j) described above. In particular, the joint probability for a particular pair of classes may obtained by normalizing the co-appearance count for the respective pair with respect to the total number of appearances of all classes. For example, the joint probability P(i, j) for a pair of classes may be determined according to

$$P ( i , j ) = \frac{A ( i , j )}{{\sum }_{i = 1 , j = 1}^{i = N , j = N} A ( i , j )} . \qquad ( 2 )$$

Although the examples described above relate to the classification of objects in images (also referred to as image classification or identification) and, in particular, make use of the COCO datasets, it will be appreciated that the approaches described above may be generalized to other datasets and/or other inference problems. Thus, probability information may be generated using different datasets in the same or a similar way. In general, Equation (1) may be used to determine a conditional probability for a pair of classes based on co-appearance counts A(i, j) for the classes i, j for any suitable dataset. Equation (2) may be used to determine a joint probability for a pair of classes based on co-appearance counts A(i, j) for the classes i, j for any suitable dataset.

The co-appearance count may relate to the pair of classes being present in the same observation (e.g., the same image). This may be described as the co-appearance count being defined on two or more semantics (e.g., class, object) within one observation. Thus, the joint probability described above may be denoted P(aᵢ, bᵢ) in which a and b are the semantics and i is the observations. The conditional probability of semantic a being present in observation i given semantic b is present in observation i may be denoted P(aᵢ|bᵢ). The conditional probability of semantic b being present in observation i given semantic a is present in observation i may be denoted P(bᵢ|aᵢ).

The co-appearance count may, alternatively, relate to the pair of classes being present in different observations (e.g., in neighboring or adjacent observations). For example, the co-appearance count may reflect how frequently a first class is present in a frame of a media clip (e.g., video) and a second class is present in the subsequent frame in the media clip. This may be described as the co-appearance count being defined on two or more semantics (e.g., class, object) across multiple observations. Thus, the joint probability described above may be denoted P(aᵢ, bᵢ) in which a and b are first and second semantics, and i and j are first and second observations. The conditional probability of semantic a being present in observation i given semantic b is present in observation j may be denoted P(aᵢ|bⱼ). The conditional probability of semantic b being present in observation j given semantic a is present in observation i may be denoted P(bⱼ|aᵢ).

Thus, the methods described above for determining probability information may be used to determine probability information for refining inference results obtained from any classification process. In this context, a classification process may be any process which seeks to classify, label or categorize data. As such, the classes referred to herein may comprise for example, classes, categories, class labels or any other suitable way of categorizing or classifying information.

It will be appreciated that classification processes are an example of inference processes to which the methods of the disclosure may be applied.

In some examples, probability information may be used for refining inference results obtained from a regression process. Regression processes are typically used to extract information from values of a plurality of variables. As such, regression may be used obtain inference results for a quantity (e.g., temperature or brightness) across multiple observations (e.g., times and/or locations). For example, a regression process may be used to identify patterns or trends in a dataset including a measurement of temperature at a plurality of points in time.

As such, in some examples, the probability information may include a joint probability P(xᵢ, xⱼ) for a first parameter x at a plurality of observations i, j. The joint probability indicates the probability of the first parameter having a value xᵢ at observation i and a value xⱼ at observation j.

The first parameter x may alternatively be referred to as a variable (e.g., a continuous or discrete variable) or a parameter. Each of the observations i, j may be at a particular instance (e.g., value) of a second parameter. For example, the value xᵢ of the first parameter x may be associated with (e.g., measured at) the second parameter y taking a particular value yᵢ. Thus, for example, the value xᵢ may be associated with a particular time tᵢ. In another example, the value xᵢ may be associated with a particular location lᵢ.

The joint probability P(xᵢ, xⱼ) of obtaining the first value xᵢ of the parameter and obtaining a second value xⱼ of the parameter may be determined according to:

$$P ( {x}_{i} , {x}_{j} ) = \frac{P ( a = {x}_{i} , b = {x}_{j} )}{\int P ( a , b ) da db} , \qquad ( 3 )$$

in which a and b may be real values. In practice, a and b may be quantized into discrete values.

Additionally or alternatively, the probability information may include a conditional probability P(xᵢ|xⱼ), which indicates the probability of the first parameter having a first value xᵢ at observation i given that the first parameter has the value xⱼ at observation j. The conditional probability may be determined according to:

$$P ( {x}_{i} \vert {x}_{j} ) = \frac{P ( a = {x}_{i} , b = {x}_{j} )}{\int P ( a , b ) da} \qquad ( 4 )$$

in which a and b may be real values. In practice, a and b may be quantized into discrete values.

In general, the methods described above may be used to obtain probability information for any inference process, such as a machine learning process or a component inference process of a distributed process, in which the distributed inference process is representative of a machine learning process. The inference process may involve a classification process and/or a regression process.

In particular, the above methods may be applied to obtain probability information which indicates, for each of a plurality of potential results obtainable from the inference process, a probability of obtaining the respective potential result and another potential result from the plurality of potential results. The potential results may include, for example, confidences associated with particular classes (e.g., for classification processes). Alternatively, the potential results may include a plurality of values for a parameter (e.g., for a regression process). The probability information may include a joint probability or a conditional probability. The probability information may alternatively be referred to as correlation information.

In some examples, the probability information may be stored in a table. The table may be referred to as a correlation table. The table may be square-shaped, in which each row and each column represents a respective semantic or an observation. The entries in the table may be joint probabilities or conditional probabilities, for example. Each row in the table may be normalized such that the sum of each row may equal 1. Each column in the table may be normalized such that the sum of each column may equal 1.

In some examples, it may be advantageous for the probability information to include the joint probability rather than the conditional probability because the joint probability is symmetric. For example, P(xᵢ,xⱼ)=P(xⱼ, xⱼ). This means that, when stored in a table, the joint probabilities will be symmetric along the diagonal. Thus, in particular embodiments the probability information may include an upper or lower triangular matrix of the joint probabilities. This reduces the storage required for storing the probability information and/or transmission resources required to transmit the probability information by half.

Methods of using the probability information to refine an inference result are now described. In this context, refining an inference result refers to determining a second inference result based on a first inference result. Although the second inference result may be more accurate and/or precise than the first inference result (e.g., such that the use of the probability information provides an improved result), it will be appreciated that this is not a requirement and that the use of the term “refining” merely implies that the second inference result differs from the first inference result as a result of using the probability information.

### Refining an Inference Result

As mentioned briefly above, probability information indicative of a probability of obtaining a particular potential result from an inference process and another potential result from the inference process may be used to refine the output of an inference process.

For example, an image classification process may return respective confidences indicating a likelihood of food, kitchen objects and outdoor objects being present in an image. Based on the confidence associated with food being present in the image being high and the likelihood of food co-appearing with the kitchen objects also being high, the confidence associated with kitchen objects being present in the image may be increased. Conversely, based on the low likelihood of food co-appearing with outdoor objects, the confidence associated with the detection of an outdoor object may be decreased.

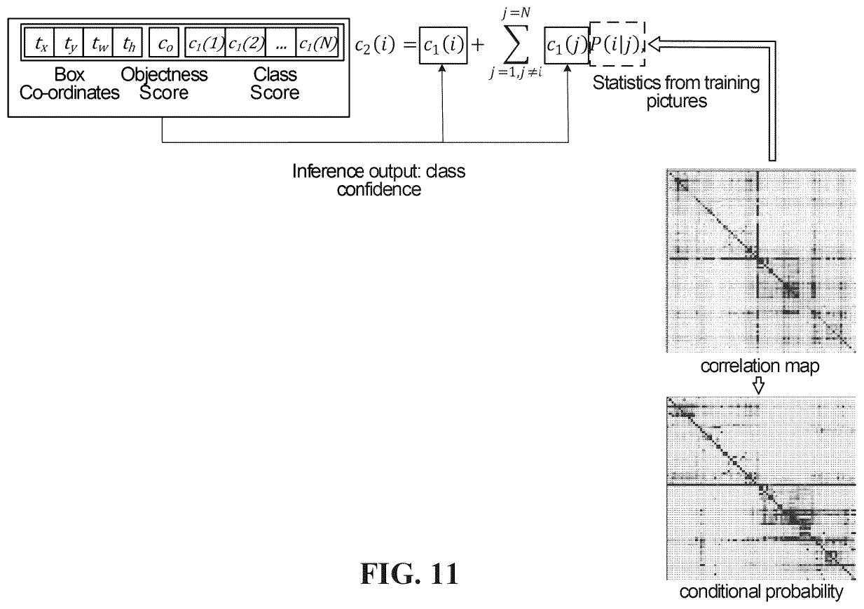

FIG. 11 shows an example of determining a refined inference result based on probability information (labelled “Statistics from training pictures) and a preliminary inference result (labelled “Inference output: class confidence”).

In this example, a preliminary inference result is obtained by inputting an image into the YOLO algorithm (Farhadi, Ali, and Joseph Redmon. “Yolov3: An incremental improvement.” Computer Vision and Pattern Recognition. Berlin/Heidelberg, Germany: Springer, 2018) which is an example of an image classification process. However, in general, any suitable inference process, such as any suitable image classification process, may be used.

The YOLO algorithm provides, based on the input image, a preliminary inference result including coordinates for a bounding box in the image, an objectness score, and an initial class confidence associated with each of N classes. The coordinates of the bounding box include an x-coordinate tₓ and a y-coordinate t_{y} of the bounding box, as well as the width t_{w} and height tₕ of the bounding box. The objectness score pₒ indicates the confidence that an object is detected in the image. The initial class confidence c₁(i) associated with respective class i indicates the likelihood that the object in the bounding box is in the class i. The class confidence may also be referred to as a class score. The initial class confidence may also be referred to as an initial marginal probability (e.g., for the particular class).

Based the conditional probabilities and the initial confidence c₁(i) for a particular class i, a refined confidence c₂(i) for the object in the image being in a class i can be determined according to:

$${c}_{2} ( i ) = {c}_{1} ( i ) + {\sum }_{j = 1 , j \neq i}^{j = N} {c}_{1} ( j ) P ( i \vert j ) , \qquad ( 5 )$$

in which the sum is over each of the other N-1 classes in the set of N classes and P(i|j) is the conditional probability of an object in class i being present given an object in class j is present. The refined confidence c₂ may be normalized according to

$${c}_{2} ( i ) = \frac{{c}_{2} ( i )}{{\sum }_{j = 1}^{j = N} {c}_{2} ( j )} . \qquad ( 6 )$$

Thus, the refined confidence for a particular class may be normalized based on the sum of the refined confidences for all the classes.

In the above example, conditional probabilities are used to refine the confidences. The refined confidence c₂(i) for the detected object being in a particular class i may be determined based on the initial confidence value c₁(i) (e.g., the confidence value provided by the inference process) and the joint probabilities according to:

$${c}_{2} ( i ) = {c}_{1} ( i ) {\sum }_{j = 1 , j \neq i}^{j = N} {c}_{1} ( j ) P ( i , j ) , \qquad ( 7 )$$

in which P(i, j) is the joint probability of objects in both classes i and j being present in the image. Further information relating to characterizing a marginalized probability, such as the refined confidence c₂(i), may be found in “Factor graphs and the sum-product algorithm.”, Frank R. Kschischang, Brendan J. Frey, and H-A. Loeliger, IEEE Transactions on information theory 47, no. 2 (2001): 498-519. In Kschischang, a factor graph is defined between random variables (variable nodes) and their relationships (check nodes). This may be adapted according to the present disclosure, by representing an object or event as a variable node and their joint probability as a check node.

The refined confidences c₂(i) for i=1, . . . . N may be normalized using the same approach described above in the method using conditional probabilities. In effect, P(i, j) is a joint probability of the co-appearance of class/object i and class/object j given the statistics from training data before executing the inference process. In contrast, c₁(i) is the probability of class i given standalone observation after executing the inference process.

Refined confidences, c₂, may be determined for each of the N classes that may be identified by the YOLO algorithm. The refined confidences c₂ may be used to classify the objects in the images. It may be determined that an object in a particular class, c₂(i) is present when the refined confidence for the class satisfies (e.g., is greater than, or greater than or equal to) a threshold. For example, it may be determined that an object in a particular class, c₂(i) is present when the following relation is satisfied:
c₂(i)>θ,
   in which θ is a threshold value. This step may be referred to as thresholding.

This example using the YOLO algorithm demonstrates how probability information may be used to refine the results from an image classification process. In general, the approaches described above may be applied to any classification process. Thus, in the context of classification problems, the probability information may be used to obtain a second, or refined, confidence c₂(i) associated with a class i based on a first, or initial, confidence c₁(i) associated with the class i.

As mentioned above, the methods described herein may be applied to other inference processes, such as regression processes.

A regression process may be operable to return an initial probability distribution P₁(xᵢ) for a parameter x at an observation i. This initial probability distribution may be referred to as an initial marginal probability distribution. The initial probability distribution may indicate the likelihood of the parameter x taking a particular value xᵢ at the observation i from a range of potential values. Thus, for example, the parameter may be a temperature with potential values in the range 0-100 degrees Centigrade. The initial probability distribution P₁(xᵢ) may indicate a likelihood that the temperature has a value xᵢ at a time tᵢ.

The initial, or first, probability distribution may be refined based on the probability information to obtain a second probability distribution. In some examples, the probability information may include a joint probability P(x, xⱼ) of obtaining the first value xᵢ of the parameter and obtaining a second value xⱼ of the parameter (e.g., determined as described above) and the second, or refined, probability distribution may be determined based on the joint probability. For example, the second probability distribution may be determined according to:

$${P}_{2} ( {x}_{i} ) = \int {P}_{1} ( {x}_{j} ) P ( {x}_{i} , {x}_{j} ) d {x}_{j} . \qquad ( 8 )$$

In other words, the second probability distribution may be determined by integrating P(xᵢ, xⱼ) over xⱼ based on the first probability distribution P₁(xⱼ) provided by the regression process. The second probability distribution may be normalized such that the total probability sums to 1. The second probability distribution may be normalized according to:

$${P}_{2} ( i ) = \frac{{P}_{2} ( i )}{\int {P}_{1} ( {x}_{j} ) P ( {x}_{i} , {x}_{j} ) d {x}_{i} d {x}_{j}} . \qquad ( 9 )$$

In some embodiments, the second probability distribution, P₂, returned by Equation (9) may already be normalized, so no further normalization is required.

In other examples, the probability information may include a conditional probability P(xᵢ|xⱼ) of obtaining the first value xᵢ of the parameter given that the parameter has a second value x (e.g., determined as described above) and the second, or refined, probability distribution may be determined based on the conditional probability. For example, the second probability distribution may be determined according to:

$${P}_{2} ( {x}_{i} ) = \int {P}_{1} ( {x}_{j} ) P ( {x}_{i} \vert {x}_{j} ) d {x}_{j} . \qquad ( 10 )$$

Thus, the second probability distribution may be determined by integrating P₁(xⱼ)P(xᵢ|xⱼ) over xⱼ based on the first probability distribution P₁(xⱼ) provided by the regression process. The second probability distribution may be normalized such that the total probability sums to 1. The second probability distribution may be normalized according to:

$${P}_{2} ( i ) = \frac{{P}_{2} ( i )}{\int {P}_{1} ( {x}_{j} ) P ( {x}_{i} \vert {x}_{j} ) d {x}_{i} d {x}_{j}} \qquad ( 11 )$$

In some embodiments, the second probability distribution, P₂, returned by Equation (11) may already be normalized, so no further normalization is required.

In summary, the marginal probability P(xᵢ) provided by the regression process can be merged with the local observation to get a refined probability distribution of P(xᵢ).

As mentioned above, some inference processes involve both regression and classification. Thus, in some examples, the methods described above in respect of regression and classification may be combined and applied to the inference results provided by an inference process. For example, the refinement techniques described above in respect of a regression process may be used to refine the co-ordinates of a bounding box provided by an image classification process and the refinement techniques described above in respect of a classification process may be used to refine the classification of an object detected in the bounding box.

### Updating Probability Information

As described above, probability information may be used to refine one or more inference results from an inference process. In some examples, an update to the probability information may be determined based on the inference results.

For example, an updated conditional probability P′^{(i|j)} of a particular class i being present given the class j is present may be determined based on the conditional probability P(i|j) and the initial confidences c₁(i) and c₁(j) of the classes i and j being present provided by the inference process. The updated conditional probability may be determined according to:

$${P}^{′} ( i \vert j ) = \frac{P ( i \vert j ) \frac{{c}_{1} ( i )}{{c}_{1} ( j )}}{{\sum }_{i} P ( i \vert j ) \frac{{c}_{1} ( i )}{{c}_{1} ( j )}} , \qquad ( 12 )$$

in which the denominator is for normalization. In some embodiments, normalization might not be necessary, and the denominator may be omitted (e.g., may be =1).

In another example, an updated joint probability P′(i, j) of a particular class i being present and the class j being present may be determined based on the joint probability P(i,j) and the initial confidences c₁(i) and c₁(j) of the classes i and j being present provided by the inference process. The updated joint probability may be determined according to:

$${P}^{′} ( i , j ) = \frac{P ( i , j ) {c}_{1} ( i ) {c}_{1} ( j )}{{\sum }_{i , j} P ( i , j ) {c}_{1} ( i ) {c}_{1} ( j )} \qquad ( 13 )$$

in which the denominator is for normalization. In some embodiments, normalization might not be necessary, and the denominator may be omitted (e.g., may be =1).

In another example, an updated conditional probability P′(xᵢ|xⱼ) of obtaining the first value xᵢ of the parameter at observation i given that the parameter has a second value xⱼ at observation j may be determined based on the initial probability distribution P₁(xᵢ) for the parameter x at the observation i and the initial probability distribution P₁(xⱼ) for the parameter x at the observation j provided by the inference process. The updated conditional probability may be determined according to:

$${P}^{′} ( {x}_{i} \vert {x}_{j} ) = \frac{P ( {x}_{i} \vert {x}_{j} ) \frac{{P}_{1} ( {x}_{i} )}{{P}_{1} ( {x}_{j} )}}{\int P ( {x}_{i} \vert {x}_{j} ) \frac{{P}_{1} ( {x}_{i} )}{{P}_{1} ( {x}_{j} ) d {x}_{i}}} \qquad ( 14 )$$

in which the denominator is for normalization. In some embodiments, normalization might not be necessary, and the denominator may be omitted (e.g., may be =1).

In another example, an updated joint probability P′(xᵢ, xⱼ) of obtaining the first value xᵢ of the parameter at observation i and obtaining the second value xⱼ of the parameter at observation j may be determined based on the initial probability distribution P₁(xᵢ) for the parameter x at the observation i and the initial probability distribution P₁(xⱼ) for the parameter x at the observation j provided by the inference process. The updated joint probability may be determined according to:

$${P}^{′} ( {x}_{i} , {x}_{j} ) = \frac{P ( {x}_{i} , {x}_{j} ) {P}_{1} ( {x}_{i} ) {P}_{1} ( {x}_{j} )}{\int P ( {x}_{i} , {x}_{j} ) {P}_{1} ( {x}_{i} ) {P}_{1} ( {x}_{j} ) d {x}_{i} d {x}_{j}} \qquad ( 15 )$$

in which the denominator is for normalization. In some embodiments, normalization might not be necessary, and the denominator may be omitted (e.g., may be =1).

In general, the probability information may be updated based on the initial, or first, inference result provided by the inference process. The initial inference result may include, one or more confidences and/or one or more probability distributions as in the examples given above. In some examples, the probability information may be updated based on the refined inference result which is determined based on the initial inference result provided by the inference process and the probability information itself.

In some examples, inference results may be obtained by a plurality of apparatus, also referred to as processing apparatus. This is described in more detail below under distributed inference and correlated coded inference. In these examples, the same probability information may be used to refine the inference results from the plurality of apparatus. The probability information may, for example, be updated based on the inference results from the plurality of apparatus. Alternatively, the probability information may be specific to a particular apparatus or to particular groups of apparatus. As such, the probability information may be updated based on the inference results from a particular apparatus or group of apparatus. In some examples, the same probability information may be initially used for a plurality of apparatus and probability information that is specific to each of the apparatus may be determined based on the same probability information by iteratively updating the probability information based on the inference results provided by the specific apparatus. That is, default probability information may initially be used for all of the apparatus and then refine according to the actual inference results provided by the apparatus.

### Refining an Inference Result From a Single Apparatus

The methods described herein may be applied to inference processes performed by a single apparatus (e.g., non-distributed inference processes). Thus, for example, a processing apparatus may perform an inference process on inference data to obtain an inference result. The inference process may involve a classification and/or a regression process. The inference result may be refined based on probability information as described above. The refinement may be performed by the same processing apparatus that performed inference. Alternatively, the refinement may be performed elsewhere. For example, an electronic device connected to a cell served by a network device may perform inference to obtain an inference result, and the electronic device may transmit the inference result to the network device for refinement using the methods described herein.

### Distributed Correlated Inference

In other examples, the methods described herein may be applied to distributed inference, in which a component inference process is performed at a plurality of processing apparatuses to obtain, at each processing apparatus, a respective initial inference result. The distributed inference process may be representative of a machine learning process such as a neural network (e.g., a deep neural network, DNN), a k-nearest neighbors process, a linear regression process, a logistic regression process, a support-vector machine, or any other suitable machine learning process. The initial, or first, inference results may be refined based on probability information obtain refined, or second, inference results using any of the methods described above. These refinement techniques may be particularly advantageous for distributed inference processes because they can be implemented without incurring a significant processing burden. They may provide improvements in inference performance at lesser computational cost than, for example, training the inference process using more training data or using a more complex inference process (e.g., using a different or more involved machine-learning process or algorithm).

The refinement may be performed at the processing apparatus or elsewhere. For example, the processing apparatus may send the initial inference results to a network device and the network device may determine the refined inference results based on the probability information and the initial inference results. By refining the inference results elsewhere (e.g., not at the processing apparatus), improvements in inference performance can be achieved without requiring further processing at the processing apparatus. This can save processing resources at the processing apparatus, which may be particularly advantageous for low-complexity and/or low power processing apparatus.

In some examples, further processing to the inference results may be performed after refinement. This may be particularly appropriate for classification processes in which the initial inference results may include a respective initial confidence for one or more classes and the refined inference results may include refined, or second, confidences for the one or more classes. According to aspects of the present disclosure, the refined confidences may be compared to a threshold to confirm the detection of the one or more classes. This may be referred to as thresholding and may be performed as described above. Thresholding may be performed by the apparatus that performs the component inference process and/or the apparatus that refines the inference results. In some examples, thresholding may be performed elsewhere. For example, a network device may obtain refined inference results and transmit the refined inference results to another apparatus (e.g., an apparatus in a core network) to perform thresholding.

### Correlated Coded Inference

In some embodiments, the methods described herein may be applied to coded inference. Inference in which the inputs are encoded provide redundancy and probability information is used to refine inference results may be referred to as a correlated coded inference.

In the system 500 described above in respect of FIG. 5, for example, a refined first inference result may be determined based on the first inference result Y₁ provided by the first inference unit 502 and probability information. The probability information may be indicative of, for each of a plurality of potential results obtainable from the component inference process performed by the first inference unit 502, a probability of obtaining the respective potential result and another potential result from the plurality of potential results. The probability information may be obtained using any of the methods described above in the section “Quantifying the Correlations in Probability Information”. The refined first inference result may be determined based on the first inference result Y₁ and the probability information using any of the methods described above in the section “Refining an Inference Result”.

Similarly, a refined second inference result may be determined based on the second inference result Y₂ provided by the second inference unit 504 and probability information. The probability information used to refine the first and second inference results may be the same or different. For example, the component inference processes at the first and second inference units 504, 506 may be capable of providing different inference results (e.g., may classify according to different classes) and the probability information may be specific to the respective component inference process.

The refinement may be performed at the respective inference unit 504, 506 or elsewhere. For example, another apparatus (not illustrated in FIG. 5) may receive the first, second and redundant inference results Y₁, Y₂ and Y₃ from the first, second and redundant inference units 502-506 and refine the first and second inference results as described above. The other apparatus may be any of the encoding unit, decoding unit or the encoder-decoder described above.

In some examples, the redundant inference result Y₃ may also be refined based on probability information using the methods described herein. This may be appropriate when the inputs X₁, X₂ are taken from similar scenarios, as this may mean that any inherent correlations in the inputs X₁, X₂ are preserved in the redundant input h(X₁,X₂). In other examples, the redundant inference results might not be refined based on probability information. As the redundant input h(X₁,X₂) combines the inputs X₁, X₂, any inherent correlations in X₁, X₂ might not be preserved in the redundant input, which may lead to unexpected results when refining the redundant inference result.

The refined inference results may be decoded (e.g., at the decoding unit or the encoder-decoder described above) to determine a missing inference result or further refine the inference results. Methods for decoding inference results from a correlated coded inference process are described in more detail below in respect of the method 1300.

An example method of implementing correlated coded inference is provided as follows:

### Step 1: Perform Independent Inference

>Get an inference result (probability) for each individual class/object/event.

### Step 2: Refine Inference By Correlation Knowledge (For Systematic Input Only)

>Update inference result (probability) according to marginal probability expression

>Normalize inference result (probability)

### Step 3: Refine Inference With Redundant Input

>“set operation” based message passing between the inference units 502, 504 and the redundant inference units 506.

>Normalize inference result (probability)

### Step 4: Obtain Final Inference Result

>Perform thresholding or make decision based on refined inference results

Step 1 may be performed in accordance with the description of performing a component inference process provided herein. Step 2 may be performed in accordance with the methods described in the section “Refining an Inference Result”. Section 3 may be performed in accordance with decoding as described in the method 1300 below. Step 4 may involve performing thresholding as described herein. Steps 1-4 may be performed one or more times (e.g., may be iteratively executed).

The message passing between the inference units 502, 504 and the redundant inference unit 506 based on a “set operation” in Step 3 may be omitted in some examples. Without Step 3, the example method becomes correlated inference only, and may be implemented in a single apparatus (e.g., without the support of a network).

### Generalization to Two or More Possible Results

In the foregoing description, the probability information is described as indicating, for each of a plurality of potential results obtainable from the component inference process, a probability of obtaining the respective potential result and another potential result from the plurality of potential results. In general, the probability information may relate to the probability of obtaining the respective potential result and one or more other potential results from the plurality of potential results. Thus, equations (1)-(15) described above may be adapted and/or generalized in embodiments in which the probability information relates to the probability of obtaining the respective potential result and two or more other potential results. For example, in an embodiment in which a classification process returns respective initial confidences c₁(i) for classes i=1,2, . . . , N, a refined confidence for a particular class, c₂(i), may be determined according to:

$${c}_{2} ( i ) = {c}_{1} ( i ) ( {\sum }_{j} {c}_{1} ( j ) ( {\sum }_{k} P ( i , j , k ) ( {\sum }_{m} P ( k , m ) ) ( {\sum }_{q} P ( k , q ) ) ) ) ,$$

in which P(i, j, k) is the joint probability of classes i, j and k being present, P(k, m) is the joint probability of k and m being present and P(k, q) is the joint probability of classes k and q being present.

### Example Methods

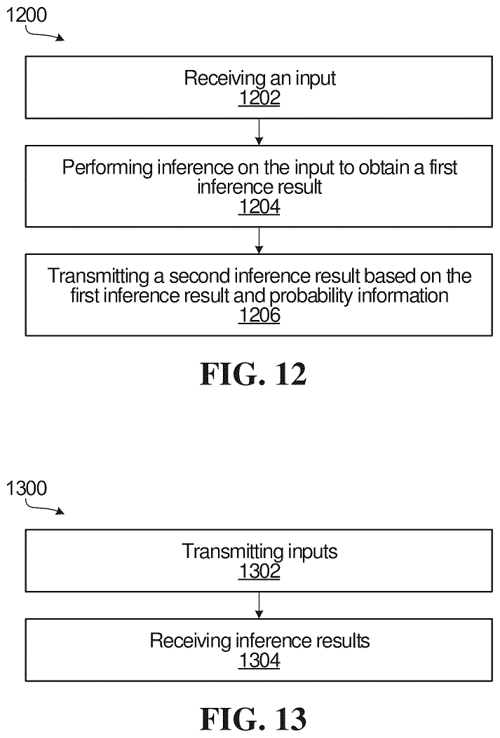

FIG. 12 shows a method 1200 according to embodiments of the disclosure. In the foregoing description, the method 1200 is described as being performed by a processing apparatus. However, in general the method 1200 may be performed by any suitable apparatus and, in some examples, by more than one apparatus. In particular examples, the method 1200 may be performed by an inference unit, such as any of the first and second inference units 502, 504 described above. In some examples, the processing apparatus may be an electronic device, such as any of the electronic devices 110 described above in respect of FIGS. 1-4. In particular examples, the processing apparatus may be a sensing apparatus. Thus, the method 1200 may be used to implement joint or collaborative sensing, for example.

The method 1200 may begin, in step 1202, with the processing apparatus receiving an input for a component inference process. In some examples, the processing apparatus receives the input from a network device. The network device may be a TRP, such as any of the TRPs 170 described above in respect of FIGS. 1-4. For example, the network device may be a base station and the processing apparatus may be connected to a cell served by the base station.

In other examples, the input may be obtained in other ways. For example, the processing apparatus may comprise a sensing apparatus and the input may comprise sensing data obtained (e.g., measured, sensed and/or calculated) by the processing apparatus.

The input may comprise any data on which inference may be performed. Thus, for example, the input may comprise one or more of: image data, audio data, video data, measurement data, network data for a communications network (e.g., indicative of traffic, usage, performance or any other network parameter), user data or any suitable data.

The component inference process forms part of a distributed inference process representative of a machine learning process. The component inference process may be any suitable process (e.g., algorithm) comprising one or more tasks to be performed as part of the distributed inference process. The component inference process and/or the distributed inference process may comprise any suitable machine learning process such as, for example, a neural network (e.g., a deep neural network, DNN), a k-nearest neighbors process, a linear regression process, a logistic regression process, a support-vector machine or any other suitable machine learning process. The component inference process and/or the distributed inference process may comprise, for example, a regression process, a classification process (e.g., a classifier) or a combination of a regression process and a classification process. The person skilled in the art will appreciate that the choice of machine learning process is often specific to the inference task. For example, the inference task may comprise image classification, and the component process may comprise a neural network, such as deep neural network, trained to classify images.

In the context of the present disclosure, the distributed inference process may be any inference process comprising tasks that can be performed by a plurality of apparatus. In some examples, the distributed inference process may be performed by a plurality of processing apparatuses, in which each processing apparatus performs a component inference process. Each processing apparatus may perform the same component inference process. Alternatively, different processing apparatus may perform different component inference processes.

In some examples, the distributed inference process may comprise a coded inference process. This is described in more detail below in respect of FIG. 13, but will be understood to apply to the method 1200 in some examples.

Continuing with the discussion of method 1200, in step 1204, the processing apparatus performs the component inference process on the input to obtain a first inference result. It will be appreciated that different inference processes provide different results and thus the form of the first inference result may depend on the component inference process, the distributed inference process and/or the machine learning process represented by the distributed inference process.

In some examples, the machine learning process may comprise a classification process and the first inference result may include one or more classes and, for each class, a respective confidence. The confidence may alternatively be referred to as a confidence score, confidence indicator, confidence level, class score, trust score or any other suitable term. The confidence indicates a likelihood that the assignment of that class based on the input is correct. For example, an image classification process may provide one or more classes for an object detected in an image and, for each class, an associated confidence indicating the likelihood that the object is in the respective class. In some examples, the confidence may take a value in the range 0 to 1, with larger values indicating that the class is more likely to be correct.

In some examples, the machine learning process represented by the distributed learning process may comprise a regression process and the first inference result may comprise a first probability distribution P₁(xᵢ) of a parameter associated with first data i. Thus, for example, step 1204 may involve performing the component inference process on an input image to obtain the respective first probability distributions for the co-ordinates of a bounding box in the image. The bounding box may indicate the presence of an object in the image, for example. As described above, a bounding box may have co-ordinates (tₓ, t_{y}, t_{w}, tₕ). Thus, the first probability distribution may comprise respective distributions P_{1,t}_{ₓ}, P_{1,t}_{_{y}}, P_{1,t}_{_{w}}, P_{1,t}_{ₕ}. The first probability distributions may take any suitable form. In some examples, the first probability distribution may include, for each of a plurality of potential values for the parameter, a respective probability.

In some examples, the machine learning process may comprise a classification and a regression process. Thus, the first result may comprise a combination of the first results described above in respect of classification and regression processes.

The method 1200 may further involve obtaining probability information. The probability information indicates, for each of a plurality of potential results obtainable from the component inference process, a probability of obtaining the respective potential result and another potential result from the plurality of potential results.

The form of the plurality of potential results may depend on the component inference process. For a classification process, the potential results may comprise a plurality of classes, for example. For a regression process, the potential results may comprise a range or set of values, for example.

The probability information may be the probability information described above in the section “Quantifying the Correlations in Probability Information”. In some examples, the processing apparatus may determine the probability information using any of the methods described in that section. In other examples, the processing apparatus may receive an indication of the probability information. The processing apparatus may receive the indication of the probability information from the network device or from another apparatus. Alternatively, the processing apparatus may be configured with the indication of the probability information.

The indication of the probability information may comprise the probability information itself. For example, the processing apparatus may receive any of the joint or and/or conditional probabilities described above. Alternatively, the indication may take another form. In particular examples, the indication may comprise an identifier for use with a look-up table available at (e.g., stored at) the processing apparatus. The look-up table may alternatively be referred to as a correlation table or belief table, for example. The processing apparatus may look up the identifier in the look-up table to determine the probability information. For example, the processing apparatus may be configured with a table such as Table 1.

TABLE 1

| ID | Probability | Meaning |
|---|---|---|
| 00 | 0 | Zero |
| 01 | <0.5 | Low |
| 10 | <1 | Medium |
| 11 | 1 | High |

Table 1 is an example of a look-up table that may be used in some embodiments of the disclosure. The table has three columns. The first column includes identifiers (IDs) that the processing apparatus may receive (e.g., from the network device). The second column includes probabilities, or probability ranges, that the processing apparatus can determine by looking up the associated identifier in the look-up table. The third column, which may be omitted, includes the meaning of the associated probability. Each probability in the look-up table may be a probability of obtaining, from the component inference process, a potential result and another potential result. Thus, for example, the identifier (ID) 00 may be associated with a conditional probability of detecting an object in the class “giraffe” in an image when an object in the class “stop sign” is also detected in the image.

Table 2 shows another example of a look-up table that may be used.

TABLE 2

| | Joint / | |
|---|---|---|
| | conditional | |
| ID | probability | Meaning |
| 00 | 0 | Independent |
| 01 | <0.5 | Weak correlation |
| 10 | <1 | Medium |
| | | correlation |
| 11 | 1 | Strong correlation |

In some examples, the processing apparatus may store the received indications such that the indications can be retrieved from memory at the processing apparatus to determine, with a look-up table, the probability information (e.g., as needed). Table 3 shows an example of a table storing, for each pair of classes in the set of Classes 1, 2 and 3, a respective identifier that may be used with a look-up table, such as Table 1 or Table 2, to determine the probability information for the respective pair. Each processing apparatus may, for example, store a table of identifiers for each combination of possible results from the component inference process. The network device may, for example, store a corresponding table. The table stored at the network device may include identifiers for each combination of possible results from the distributed inference process (e.g., the possible results from all of the component inference processes that form part of the distributed inference process). The network device may store a larger table than any individual processing apparatus.

TABLE 3

| Correlation | | | |
|---|---|---|---|
| ID | Class 1 | Class 2 | Class 3 |
| Class 1 | 11 | 10 | 01 |
| Class 2 | 10 | 11 | 00 |
| Class 3 | 01 | 00 | 11 |

Although the above description refers to the processing apparatus receiving an identifier, it will be appreciated that in general the processing apparatus may receive one or more identifiers. In some examples, the processing apparatus may receive an identifier for each combination of potential results that are obtainable from the component inference process. For example, the processing apparatus may receive a table, such as Table 3, which includes a respective identifier for each pair of classes obtainable from a component classification process. In general, the probability information may be quantized and/or encoded in any suitable way in the indication.

The processing apparatus may further determine a second inference result based on the first inference result and the probability information. The processing apparatus may thus refine the first inference result based on the probability information. This step may be performed using any of the methods described above in the “Refining an Inference Result” section, for example.

In step 1206, the processing apparatus transmits the second inference result to the network device.

The method 1200 may also involve updating the probability information based on the first inference result and/or the second inference result.

The processing apparatus may indicate the updated probability information to the network device. The processing apparatus may send the probability information itself to the network device. Alternatively, the processing apparatus may indicate the update to the probability information using other means. For example, the processing apparatus may send, for each combination of potential results, an updated identifier. The network device may determine, based on the updated identifier, a probability for the combination of potential results (e.g., using a look-up table, such as any of the look-up tables described above).

The processing apparatus may, additionally or alternatively, indicate the updated probability information to another apparatus, such as another processing apparatus. In some examples, the processing apparatus may send the updated probability information to another processing apparatus (e.g., to another apparatus configured to perform a component inference as part of the distributed learning process). The processing apparatus may indicate the updated probability information to another apparatus using any of the methods described above in respect of indicating the updated probability information to the network device.

In some examples, the processing apparatus may receive an indication of an update to the probability information. The processing apparatus may receive the indication from the network device or from another apparatus, such as another processing apparatus (e.g., another apparatus configured to perform a component inference process as part of the distributed inference process). In some examples, each of the processing apparatus may exchange its (updated) probability information with at least one other processing apparatus. The updated probability information at a particular processing apparatus may be referred to as local correlation information. Each processing may thus, for example, exchange its local correlation information with its neighboring processing apparatus.

The processing apparatus may update the probability information based on the received indication of the update to the probability information. The processing apparatus may update the probability information using any of the methods described above in the section “Updating probability information”.

An apparatus configured to perform the method 1200 is also provided. In yet another aspect, a memory (e.g., a non-transitory processor-readable medium) is provided. The memory contains instructions (e.g., processor-executable instructions) which, when executed by a processor of an apparatus, cause the apparatus to perform the method 1200. In yet another aspect, an apparatus comprising a processor and a memory is provided. The memory contains instructions (e.g., processor-executable instructions) which, when executed by the processor, cause the apparatus to perform the method 1200.

FIG. 13 shows a flowchart of a method 1300 performed by a network device according to embodiments of the disclosure. The network device may be a TRP, such as any of the TRPs 170 described above in respect of FIGS. 1-4. The network device may be the network device referred to in the description of the method 1200 above.

In step 1302, the network device transmits, to each of a plurality of processing apparatuses, a respective first input in a plurality of first inputs. Some or all of the plurality of processing apparatuses may be configured to perform the method 1200 described above. Some or all of the processing apparatus may thus, for example, be the processing apparatus described above in respect of the method 1200. The processing apparatus may be electronic devices. In some examples, the processing apparatus may be connected to a cell served by the network device.

Each of the plurality of processing apparatuses is configured to perform a component inference process as part of a distributed inference process representative of a machine learning process. The component inference process, distributed inference process and/or machine learning process may be as described above in respect of the method 1200.

Each of the first inputs is for the component inference process at the respective processing apparatus.

The method may also involve indicating, by the network device, probability information to the plurality of processing apparatuses. The probability information is defined as described above in the description of the method 1200. The processing apparatus may receive the indication of the probability information in accordance with receiving an indication of probability information in the method 1200 described above. Thus, for example, the network device may transmit the probability information itself to the network device or an indication (e.g., an identifier) that allows the processing apparatus to determine the probability information.

In some examples, the network device may indicate the same probability information to all of the processing apparatus. The network device may, for example, broadcast the same probability information. The same probability information may, for example, indicate a probability of obtaining the respective potential result and another potential result from the plurality of potential results obtainable from the distributed inference process. Thus, the plurality of potential results may be results obtainable by any of the component inference processes. The same probability information may alternatively be referred to as global probability information or global correlation information. The network device may thus perform a broadcast to distribute the global correlation information to inference units (e.g., to the processing apparatus).

In other examples, the probability information indicated by the network device may be specific to the particular processing apparatus. The probability information may be specific to the component inference process which the particular processing apparatus is configured to perform. The plurality of potential results that are obtainable from the component inference process may differ from one processing apparatus for another. For example, one processing apparatus may be able to classify input data using a smaller number of classes than another processing apparatus. As such, the network device may only probability information to a particular processing apparatus that relates to the potential results obtainable from the component inference process to be performed by the particular processing apparatus. Sending only the probability information that is relevant to the particular processing apparatus can save transmission resources for the network device and the processing apparatus, whilst also saving memory at the processing apparatus.

For example, the network device may store probability information comprising a 100×100 table which includes, for each of 100 classes, a respective probability of each class co-appearing with another class. However, a first processing apparatus, referred to as user equipment A (UE_{A}) may only be operable to classify data according to 50 classes. A second processing apparatus, referred to as user equipment B (UE_{B}) may be operable to classify data according to 5 classes. Therefore, the network device may extract a 50×50 table from the full 100×100 table, and send to the 50×50 table to the UE_{A} as probability information. The network device may extract a 5×5 table from the full 100×100 table, and send to the 5×5 table to the UE_{B} as probability information. This can reduce communication overhead between the network device and UE_{A} and UE_{B} and save memory at UE_{A} and UE_{B}.

Thus, in some examples, the plurality of potential results obtainable from the component inference process may be a first plurality of potential results and the network device may obtain second probability information indicating, for each of a second plurality of potential results obtainable from the distributed inference process, a probability of obtaining the respective potential result and another potential result from the second plurality of potential results. The first plurality of potential results may be a subset of the second plurality of potential results. The network device may, for one or more (e.g., each) of the at least one of the plurality of processing apparatuses, selecting the first probability information from the second probability information based on the first plurality of potential results. Thus, the network device may, for one or more of the processing apparatus, send a subset of the probability information to the respective processing apparatus based on the plurality of potential results obtainable by the component inference process to be performed by the respective processing apparatus.

In some examples, the probability information may be specific to a particular location (e.g., a particular area). For example, a processing apparatus may be provided with particular probability information based on its location. This may be particularly appropriate when the input to the component inference process at a particular processing apparatus is specific to the location of the processing apparatus. By using location-specific probability information, inference can be tailored according to the location of the processing apparatus, which may further improve performance. For example, an electronic device entering an area (e.g., cell) of a network may be provided with probability information based on the area (e.g., specific to the cell). In some sense, the probability information may be reflective of historic knowledge (or prior knowledge) regarding to where it is created.

In some examples, the processing apparatus may not receive the probability information from the network device. Rather, the processing apparatus may obtain the probability information through other means. For example, the processing apparatus may be configured with the probability information or receive it from another apparatus.

In step 1304, the network device receives first inference results from the plurality of processing apparatuses. The first inference results are obtained, at the processing apparatus, based on the probability information and the plurality of first inputs. Thus, the first inference results received in step 1304 are refined, at the processing apparatus, based on the probability information before they are transmitted to the network device. The first inference results may be obtained using any of the methods described above in the “Refining an Inference Result” section, for example. Step 1304 may correspond to step 1206 described above.

The network device may also receive an update to the probability information from at least one of the processing apparatus. In some examples, the network device may receive respective updates from all of the processing apparatus. The update may be based on the first inference result obtained from the component inference process. The update may be determined using any of the described above in the section “Updating probability information”. The at least one processing apparatus may transmit the update to the network device in accordance with the indication of the updated probability information to the network device described above in the method 1200.

The network device may update its probability information (e.g., the global probability information) based on the updates received from the at least one processing apparatus. In the simplest example, the network device may replace its probability information with the update received from a processing apparatus. In another example, the network device may average the probability information received from all of the at least one processing apparatus. The network device may weigh the average based on, for example, the size of the input processed by the respective processing apparatus and/or a confidence (e.g., trust in) the respective processing apparatus.

As mentioned above, the probability information may be specific to a particular processing apparatus and/or to a particular location. The network device may thus, update the probability information for a particular processing apparatus based on the update received from the apparatus only. In another example, the network device may update the probability information for a location (e.g., a particular area) based updates received from one or more processing apparatus in or associated with the location. This can enable a network device or a wireless network to adaptively match a target application according to a specific geolocation and/or a specific scenario.

In the foregoing description of the method 1300, the network device transmits a plurality of first inputs to a plurality of processing apparatuses as part of a distributed inference process. In some embodiments, the plurality of first inputs comprises a plurality of second inputs and at least one redundant input. The at least one redundant input is redundant to the extent that it comprises data which is also contained in the plurality of second inputs. As such, the at least one redundant input may be used to recover a missing inference result from the distributed inference process and/or to refine an inference result from the distributed inference process, for example.

The distributed inference process may thus comprise a coded inference process. The network device may, prior to transmitting the first inputs, process the plurality of second inputs to generate the at least one redundant input. This processing may be referred to as encoding since it provides redundancy in a manner analogous to coding theory.

In some examples, the plurality of second inputs are processed such that each of the at least one redundant input comprises a concatenation of data from at least two of the plurality of second inputs. In this context, concatenation may refer to joining data from at least two of the plurality of inputs without mixing data from different inputs. Thus, for example, data from at least two of the plurality of inputs may be combined into a common dataset without superposition (e.g., addition) of data from different inputs. For example, data from at least two of the plurality of inputs may be placed side by side in the same dataset. Data from one input may be appended to another, for example. In a further example, data from, for example, three or more datasets may be tiled. Tiling may be particularly appropriate for data having two or more dimensions. By generating the redundant inputs in this manner, the same component inference process may be used at the processing apparatus that perform inference on the redundant inputs as on the processing apparatus that perform inference on the second inputs.

The method 1300 may further involve the network device, after receiving the first inference results from the plurality of processing results, decoding the first inference results to obtain second inference results. The first inference results include redundant results based on the at least one redundant input and other first results based on the plurality of second inputs. The decoding may be performed on at least two of the first inference results, in which the at least two first inference results include a redundant result. In other words, decoding may be performed on at least one of the one or more redundant results and zero or more of the other first results. Thus, for example, decoding may be performed based on two or more redundant results. Alternatively, decoding may be performed on at least one of the redundant results or one or more of the other first results.

The second inference result may comprise, for example, an estimate of a missing result from one instance of the same component inference process (e.g., a result that should have been returned by a processing apparatus, but was not). Even when no data is lost from the distributed inference process, decoding the results and the redundant results using said process can still be advantageous, as it can provide a more accurate and/or insightful second inference result.

In examples in which the at least one redundant input comprises a concatenation of data from at least two of the plurality of second inputs, the network device may decode the first inference results by performing one or more linear operations and/or one or more set operations. The performance of one or more set operations may be particularly appropriate in examples in which the machine learning process comprises a classification process such that the first inference results include a plurality of classes and one or more redundant classes.

There are various ways in which linear operations may be used to decode the first inference results. This may depend on, for example, the first inference results, the distributed inference process and/or the inference sought. In this context, a linear operation is any operation which preserves the operations of vector addition and scalar multiplication. Thus, the one or more linear operations may comprise any operation f(.) that satisfies

$$f ( x + y ) = f ( x ) + f ( y ) ;$$

$$f ( ax ) = af ( x )$$

for all x and y, and all constants a. The performance of one or more linear operations may be particularly appropriate in examples in which the machine learning process comprises a regression process.

There are various ways in which set operations may be used to decode the first inference results. The performance of one or more set operations may be particularly appropriate in examples in which the machine learning process comprises a classification process such that the first inference results include a plurality of classes and one or more redundant classes. In some examples, a belief propagation process (e.g., algorithm) may be used to decode the first inference results. This may be illustrated by considering an example in which the redundant classes form a set R, the classes in the first inference results form a set S and N is the neighbor set. The classes in the first inference results, i, can be decoded to obtain classes for the second inference results j by performing the following steps one or more times:

$$\{ {class}_{j \to i} \} = \{ {class}_{{i}^{′}} , {i}^{′} ∈ N ( j ) ⋂ R \} - union ( \{ {class}_{{i}^{″}} \} for all {i}^{″} ∈ N ( j ) ⋃ S and {i}^{″} \neq i )$$

$$\{ {class}_{i \to j} \} = \{ {class}_{i} \} ⋃ union ( \{ {class}_{{j}^{′} \to i} \} for all {j}^{′} ∈ N ( i ) and {j}^{′} \neq j )$$

$$\{ {class}_{i} \} = \{ {class}_{i} \} ⋃ union ( \{ {class}_{{j}^{′} \to i} \} for all {j}^{′} ∈ N ( i ) )$$

in which ∪ denotes a union of two classes and “union” denotes union of more than two classes, “-” denotes set difference, and ∩ denotes set intersection. The Neighbor set, N, for a particular class j may comprise each out of the labels used to infer class j. This particular belief propagation process may reduce the complexity of decoding because the classes in the second inference results can be determined without performing an exhaustive search. Belief propagation processes may be particularly suitable when a sparse code is used for encoding since the belief propagation process converges more quickly for sparse codes.

Whilst this example of a belief propagation algorithm uses the union, intersection and difference set operations, any suitable set operations may, in general, be used to decode the first inference results. Thus, for example, the one or more set operations may comprise one or more of: union, intersection, complement, and difference.

A network device configured to perform the method 1300 is also provided. In yet another aspect, a memory (e.g., a non-transitory processor-readable medium) is provided. The memory contains instructions (e.g., processor-executable instructions) which, when executed by a processor of a network device, cause the network device to perform the method 1300. In yet another aspect, a network device comprising a processor and a memory is provided. The memory contains instructions (e.g., processor-executable instructions) which, when executed by the processor, cause the network device to perform the method 1300.

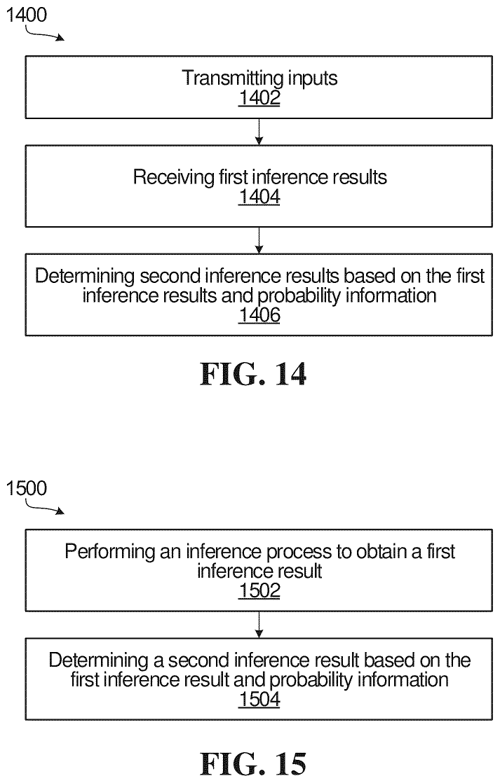

In the method 1300, the first inference results received in step 1304 are refined, at the processing apparatus, based on the probability information before they are received at the network device. In other embodiments, the network device may use probability information to refine the inference results provided by the component inference processes. This is described in respect of FIG. 14, which shows a flowchart of a method 1400 performed by a network device according to embodiments of the disclosure. The network device may be a TRP, such as any of the TRPs 170 described above in respect of FIGS. 1-4.

The method 1400 may be substantially the same as the method 1300, except for the network device, rather than the processing apparatus, refining the inference results based on the probability information.

The method 1400 involves, in step 1402, the network device transmitting a plurality of first inputs to a plurality of processing apparatuses. Each a respective first input in the plurality of first inputs is for a component inference process at the respective processing apparatus as part of a distributed inference process representative of a machine learning process. Step 1402 may be performed in accordance with step 1302.

In step 1404, the network device receives, from the plurality of processing apparatuses, first inference results based on the plurality of first inputs. Step 1404 may be performed in accordance with step 1304, except for that the first inference results in step 1404 are not based on the probability information. As such, in the method 1400 the processing apparatus might not obtain the probability information as described above in the method 1300.

In step 1406, the network device determines second inference results based on the first inference results and probability information. The probability information is defined as described above in the description of the methods 1200 and 1300.

The network device 1406 may also update the probability information based on the first inference results and/or the second inference results. The network device 1406 may update the probability information based on the inference results from all the processing apparatus. Alternatively, the network device 1406 may maintain distinct probability information for each processing apparatus or for groups of processing apparatus. Thus, for example, the network device 1406 may update the probability information for a group of one or more processing apparatus based on the inference results for the processing apparatus in the group. The network device may update the probability information using any of the methods described above in the section “Updating probability information”.

In the foregoing description of the method 1400, the network device transmits a plurality of first inputs to a plurality of processing apparatuses as part of a distributed inference process. In some embodiments, the plurality of first inputs comprises a plurality of second inputs and at least one redundant input. The distributed inference process may thus comprise a coded inference process. This may be implemented in the same way as the coded inference process described above in respect of the method 1300.

Thus, the network device may encode the plurality of second inputs to generate the at least one redundant input. The network device may also decode the second inference results to obtain third inference results. The network device may thus decode inference results after refining the inference results based on the probability information. The network device may thus use the redundancy to recover missing results and/or further refine the results after the probability information is used to refine the inference results.

A network device configured to perform the method 1400 is also provided. In yet another aspect, a memory (e.g., a non-transitory processor-readable medium) is provided. The memory contains instructions (e.g., processor-executable instructions) which, when executed by a processor of a network device, cause the network device to perform the method 1400. In yet another aspect, a network device comprising a processor and a memory is provided. The memory contains instructions (e.g., processor-executable instructions) which, when executed by the processor, cause the network device to perform the method 1400.

Although many of the examples described herein are provided in the context of distributed inference, it will be appreciated that many of the techniques described herein are also applicable in the context of inference performed by a single apparatus.

FIG. 15 shows a flowchart of a method 1500 according to embodiments of the disclosure. The method 1500 may be implemented by any suitable apparatus, such as an electronic device or a network device.

The method 1500 may involve obtaining input data. The input data may be obtained by, for example, receiving the input data from another apparatus. In some examples, the input data may be collated from a plurality of apparatus.

The method 1500 involves, in step 1502, performing an inference process on input data to obtain a first inference result. The inference process may involve a machine learning process, such as any suitable machine learning process such as, for example, a neural network (e.g., a deep neural network, DNN), a k-nearest neighbors process, a linear regression process, a logistic regression process, a support-vector machine or any other suitable machine learning process. The inference process may comprise, for example, a regression process, a classification process (e.g., a classifier) or a combination of a regression process and a classification process. The person skilled in the art will appreciate that the choice of machine learning process is often specific to the inference task. For example, the inference task may comprise image classification, and the component process may comprise a neural network, such as deep neural network, trained to classify images.

In step 1504, the method 1500 involves determining a second inference result based on the first inference result and probability information, wherein the probability information indicates, for each of a plurality of potential results obtainable from the inference process, a probability of obtaining the respective potential result and another potential result from the plurality of potential results. Step 1504 may be performed in accordance with the determination of the second inference result described above in the method 1200 or in accordance with the step 1406 described above, with the inference process replacing the component inference process referred to above.

The method 1500 may also involve transmitting the second inference result to another apparatus. The other apparatus might be the same apparatus which provided the input data or a different apparatus. In some examples, the method 1500 may involve using the second inference result.

An apparatus configured to perform the method 1500 is also provided. In yet another aspect, a memory (e.g., a non-transitory processor-readable medium) is provided. The memory contains instructions (e.g., processor-executable instructions) which, when executed by a processor of an apparatus, cause the apparatus to perform the method 1500. In yet another aspect, an apparatus comprising a processor and a memory is provided. The memory contains instructions (e.g., processor-executable instructions) which, when executed by the processor, cause the apparatus to perform the method 1500.

### Results

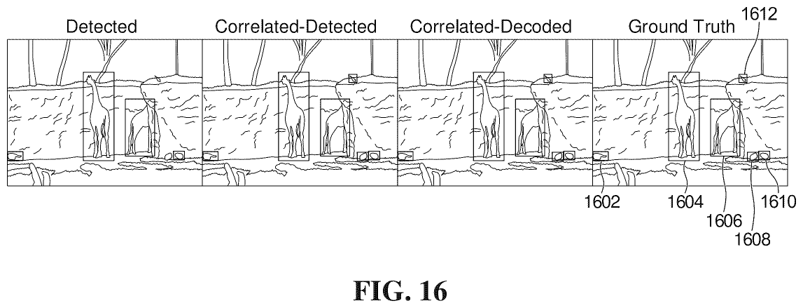

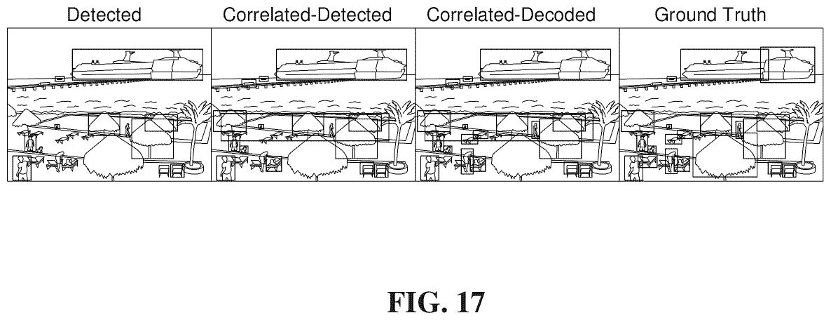

FIGS. 16 and 17 show simplified line drawings based on photographs on which distributed inference representative of an image classification process was performed. In each figure, four copies of a respective images are shown. Boxes are overlaid to show the objects identified in each image. In both figures, the right-most image shows the objects which are identified in those images manually (e.g., by a person). These images represent the “Ground Truth”; that is, the information that the image classification process seeks to obtain.

In FIG. 16, the Ground Truth image shows a first bird 1602, a first giraffe 1604, a second giraffe 1606, a second bird 1608, a third bird 1610 and a fourth bird 1612. In FIG. 17, the underlying image shows three boats in the background, with a crowded scene of umbrellas, people, and lounge chairs in the foreground. In the Ground Truth image, all of the boats, umbrellas, people and lounge chairs are detected and identified.

In both FIG. 16 and FIG. 17, the three further images are labelled, from left-to-right, “Detected”, “Correlated-Detected” and “Correlated-Decoded”. These images show the objects detected in the image when three different approaches are used. In all three approaches, the objects are detected and classified using a YOLOv3 model (Farhadi, Ali, and Joseph Redmon. “Yolov3: An incremental improvement.” Computer Vision and Pattern Recognition. Berlin/Heidelberg, Germany: Springer, 2018) trained using the COCO-train2017 dataset (Lin, Tsung-Yi, et al. “Microsoft coco: Common objects in context.” European conference on computer vision. Springer, Cham, 2014). For the Correlated-Detected image, the confidences associated with the initial classifications provided by the YOLOv3 model were refined based on probability information using the methods described herein. For the Correlated-Decoded image, both probability information and redundancy provided by coding inference were implemented to classify the objects in the image using the methods described herein.

As shown in FIG. 16, all of the objects 1602-1610 except for the fourth bird 1612 are detected (e.g., have boxes around them) in the Detected image, indicating that the YOLOv3 model is able to correctly detect and identify the objects 1602-1610. These objects are also detected in the Correlated-Detected and Correlated-Decoded images, showing that using probability information does not degrade classification performance. In addition, the fourth bird 1612 is detected and identified as a bird (e.g., has a box around it) in both the Correlated-Detected and Correlated-Decoded images. This shows that using probability information to refine inference results in accordance with the methods described herein can improve the performance of image classification processes and, in particular, can enable correctly detecting and identifying small objects in images. Whilst FIG. 16 is illustrative of this advantage, this improvement was found when the methods described herein were used to classify objects in other images.

As shown in FIG. 17, fewer objects are detected in the Detected image compared to the Correlated-Detected and Correlated-Decoded images. This shows that using probability information to refine inference results in accordance with the methods described herein can improve the performance of image classification processes by correctly detecting and identifying more objects and in particular, more objects in crowded images. In FIG. 17 more objects are detected and identified in the Correlated-Decoded image than in the Correlated-Detected image. This shows that using probability information and the redundancy provided by coded inference to refine inference results in accordance with the methods described herein can further improve the performance of image classification processes. The performance gain obtained by using both probability information (also referred to as correlated inference) and coded inference shows that these techniques can reinforce each other.

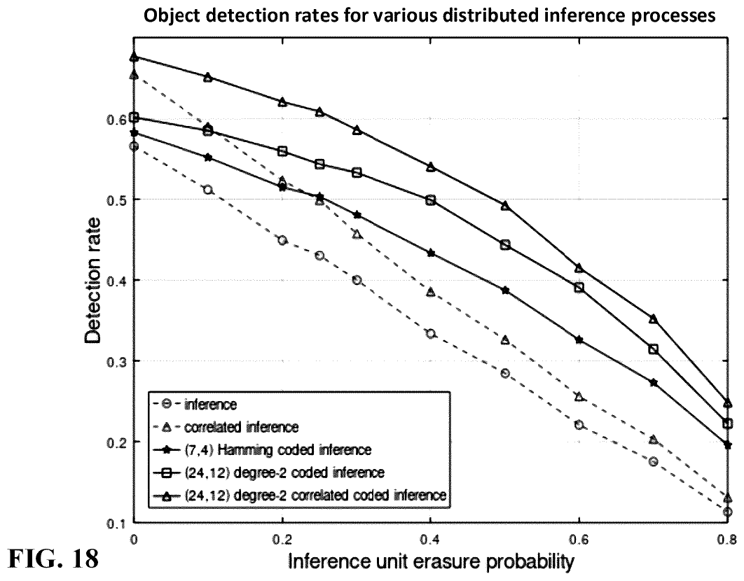

The improved performance provided by the methods disclosed herein may be further illustrated by reference to FIG. 18, which shows object detection rates for distributed inference processes performed according to embodiments of the disclosure.

In each example shown in FIG. 18, a YOLOv3 model (Farhadi, Ali, and Joseph Redmon. “Yolov3: An incremental improvement.” Computer Vision and Pattern Recognition. Berlin/Heidelberg, Germany: Springer, 2018) was trained using the COCO-train2017 dataset (Lin, Tsung-Yi, et al. “Microsoft coco: Common objects in context.” European conference on computer vision. Springer, Cham, 2014). Inference was performed on images from the COCO-val2017 dataset (Lin, Tsung-Yi, et al. “Microsoft coco: Common objects in context.” European conference on computer vision. Springer, Cham, 2014.) to detect 36781 labelled objects in 5000 images. Each of the input images were input to a respective instance of the trained YOLOv3 model, which output bounding box estimates and class predictions for one or more objects detected in the image.

This process was repeated at erasure probabilities ranging from 0 to 0.8, in which the erasure probability indicates the likelihood of each instance of the YOLOv3 model returning its respective output. Thus, for example, an erasure probability of 0 indicates that all of the outputs of the YOLOv3 models were returned.

The lower dashed line with circle markers (labelled “inference”) shows the detection rate for an inference process performed without use of a probability information or redundancy (e.g., without encoding). The dashed line with triangle markers (labelled “correlated inference”) show the detection rate for a distributed inference process according to embodiments of the disclosure, in which probability information was used to refine the inference results. The solid line with star markers (labelled “(7,4) Hamming coded inference”) shows the detection rate for object detection performed by a distributed inference process in which the input images were encoding according to a (7,4) Hamming code with the following parity check matrix:

$$H = ( \begin{matrix}1 & 1 & 1 & 0 & 1 & 0 & 0 \\ 1 & 1 & 0 & 1 & 0 & 1 & 0 \\ 1 & 0 & 1 & 1 & 0 & 0 & 1\end{matrix} )$$

Thus, a (7, 4) Hamming code was used to generate 7 inputs comprising 4 input images and 3 redundant input images. The generator matrix for this Hamming code may be expressed as:

$$G = ( \begin{matrix}1 & 0 & 0 & 0 & 1 & 1 & 1 \\ 0 & 1 & 0 & 0 & 1 & 1 & 0 \\ 0 & 0 & 1 & 0 & 1 & 0 & 1 \\ 0 & 0 & 0 & 1 & 0 & 1 & 1\end{matrix} )$$

The solid line with square markers (labelled “(24,12) degree-2 coded inference”) shows for an implementation using a (24,12) code with degree-2. For the (24,12) code, the images were grouped into batches of 12 images, and 12 redundant images were generated for each batch such that 24 images were input to instances of YOLOv3 for each batch. As the (24,12) code is degree-2, each redundant image contains data from two images. The parity check matrix for the (24,12) degree-2 code may be expressed as:

$$H = ( \begin{matrix}1 & 1 & 0 & 0 & 0 & 0 & 0 & 0 & 0 & 0 & 0 & 0 & 1 & 0 & 0 & 0 & 0 & 0 & 0 & 0 & 0 & 0 & 0 & 0 \\ 0 & 0 & 1 & 1 & 0 & 0 & 0 & 0 & 0 & 0 & 0 & 0 & 0 & 1 & 0 & 0 & 0 & 0 & 0 & 0 & 0 & 0 & 0 & 0 \\ 0 & 0 & 0 & 0 & 1 & 1 & 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 1 & 1 & 0 & 0 & 0 & 0 & 0 & 0 & 0 & 1 & 0 & 0 & 0 & 0 & 0 & 0 & 0 & 0 \\ 0 & 0 & 0 & 0 & 0 & 0 & 0 & 0 & 1 & 1 & 0 & 0 & 0 & 0 & 0 & 0 & 1 & 0 & 0 & 0 & 0 & 0 & 0 & 0 \\ 0 & 0 & 0 & 0 & 0 & 0 & 0 & 0 & 0 & 0 & 1 & 1 & 0 & 0 & 0 & 0 & 0 & 1 & 0 & 0 & 0 & 0 & 0 & 0 \\ 0 & 1 & 1 & 0 & 0 & 0 & 0 & 0 & 0 & 0 & 0 & 0 & 0 & 0 & 0 & 0 & 0 & 0 & 1 & 0 & 0 & 0 & 0 & 0 \\ 0 & 0 & 0 & 1 & 1 & 0 & 0 & 0 & 0 & 0 & 0 & 0 & 0 & 0 & 0 & 0 & 0 & 0 & 0 & 1 & 0 & 0 & 0 & 0 \\ 0 & 0 & 0 & 0 & 0 & 1 & 1 & 0 & 0 & 0 & 0 & 0 & 0 & 0 & 0 & 0 & 0 & 0 & 0 & 0 & 1 & 0 & 0 & 0 \\ 0 & 0 & 0 & 0 & 0 & 0 & 0 & 1 & 1 & 0 & 0 & 0 & 0 & 0 & 0 & 0 & 0 & 0 & 0 & 0 & 0 & 1 & 0 & 0 \\ 0 & 0 & 0 & 0 & 0 & 0 & 0 & 0 & 0 & 1 & 1 & 0 & 0 & 0 & 0 & 0 & 0 & 0 & 0 & 0 & 0 & 0 & 1 & 0 \\ 1 & 0 & 0 & 0 & 0 & 0 & 0 & 0 & 0 & 0 & 0 & 1 & 0 & 0 & 0 & 0 & 0 & 0 & 0 & 0 & 0 & 0 & 0 & 1\end{matrix} )$$

The solid line with the triangle markers (labelled “(24, 12) degree-2 correlated coded inference”) show the detection rate for a distributed inference process according to embodiments of the disclosure, in which probability information was used to refine the inference results and the inputs were encoded according to the (24,12) code described above.

As shown in FIG. 18, using probability information to refine the inference alone (e.g., without any redundancy) results significantly improves performance across all erasure rates, although the strongest improvement is shown at low erasure rates. When probability information is used in combination with the redundancy provided by coded inference, the performance increases further. This demonstrates that correlated inference and coded inference can reinforce each other. In particular, correlated coded inference can enhance the detection rate by over 20% for at least some erasure rates.

Although many of the examples provided above are described in the context of image classification, it will be appreciated that the present disclosure is not limited as such, Aspects of the present disclosure may be implemented in a wide range of applications, such as networked inference, environment sensing and/or autonomous driving. Aspects of the present disclosure may be implemented in a wide range of system architectures. The embodiments described herein may be implemented in various communication networks, such as 5G, 6G and Wi-Fi. In some cases, a network is not necessary. In some examples, aspects of the present disclosure may be implemented in a next-generation mobile and wireless network service, a cloud and edge computing service, and/or a sensing service. Aspects of the present disclosure may be implemented to enable joint sensing or detection in a wireless network, for example.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

1. A method comprising:
receiving, from a network device, an input for a component inference process that forms part of a distributed inference process representative of a machine learning process;
performing the component inference process on the input to obtain a first inference result; and
transmitting, to the network device, a second inference result based on the first inference result and probability information, wherein the probability information indicates, for each potential result of a plurality of potential results obtainable from the component inference process, a respective probability of obtaining a respective potential result and another potential result from the plurality of potential results.

2. The method of claim 1, wherein:
the machine learning process comprises a classification process,
the plurality of potential results comprises a plurality of classes such that the probability information indicates, for each class of the plurality of classes obtainable from the component inference process, a second respective probability of obtaining the respective class and another class from the plurality of classes, and
the first inference result comprises, for each class i in the plurality of classes, a respective first confidence c₁(i), and the second inference result comprises, for each class i in the plurality of classes, a respective second confidence c₂(i).

3. The method of claim 2, wherein the probability information comprises, for each class i in the plurality of classes, a respective conditional probability, P(i, j|j), of obtaining the respective class i and the another class j from the plurality of potential results given the another class j has been obtained from the component inference process, and wherein the method further comprises determining the respective second confidence c₂(i) for the respective class i in the plurality of classes according to:
$${c}_{2} ( i ) = {c}_{1} ( i ) + {\sum }_{j} {c}_{1} ( j ) P ( i , j \vert j ) .$$

4. The method of claim 1, wherein:
the machine learning process comprises a regression process,
the plurality of potential results comprises a plurality of values of a parameter, and
the first inference result comprises a first probability distribution P₁(xᵢ) of the parameter associated with first data i in the input and the second inference result comprises a second probability distribution P₂(xᵢ) of the parameter associated with the first data i, x₁ being a first value of the parameter.

5. The method of claim 4, wherein the probability information comprises a joint probability P(xᵢ, xᵢ) of obtaining the first value xᵢ of the parameter and obtaining a second value xⱼ of the parameter, and wherein the method further comprises determining the second probability distribution P₂(xᵢ) according to
$${P}_{2} ( {x}_{i} ) = \int {P}_{1} ( {x}_{j} ) P ( {x}_{i} , {x}_{j} ) d {x}_{j} .$$

6. The method of claim 4, wherein the probability information comprises a conditional probability P(xᵢ|xⱼ) of obtaining the first value xᵢ of the parameter given a second value xⱼ of the parameter has been obtained, and wherein the method further comprises determining the second probability distribution P₂(xᵢ) according to:
$${P}_{2} ( {x}_{i} ) = \int {P}_{1} ( {x}_{j} ) P ( {x}_{i} \vert {x}_{j} ) d {x}_{j} .$$

7. The method of claim 1, further comprising:
receiving an indication of the probability information from the network device; and
updating the probability information based on the first inference result or the second inference result.

8. A method performed by a network device, the method comprising:
transmitting, to each of a plurality of processing apparatuses, a respective first input in a plurality of first inputs, the respective first input being for a respective component inference process as part of a distributed inference process representative of a machine learning process; and
receiving, from the plurality of processing apparatuses, first inference results obtained based on probability information and the plurality of first inputs, wherein the probability information indicates, for each potential result of a plurality of potential results obtainable from the respective component inference process, a respective probability of obtaining a respective potential result and another potential result from the plurality of potential results.

9. The method of claim 8, wherein the plurality of first inputs comprises a plurality of second inputs and at least one redundant input, the method further comprising:
encoding the plurality of second inputs to generate the at least one redundant input; and
decoding the first inference results to obtain second inference results.

10. The method of claim 8, further comprising:
receiving, from at least one of the plurality of processing apparatuses, a respective update to the probability information based on the first inference results obtained from the respective component inference process.

11. An apparatus comprising:
at least one processor; and
a memory storing instructions which, when executed by the at least one processor, cause the apparatus to:
receive, from a network device, an input for a component inference process that forms part of a distributed inference process representative of a machine learning process;
perform the component inference process on the input to obtain a first inference result; and
transmit, to the network device, a second inference result based on the first inference result and probability information, wherein the probability information indicates, for each potential result of a plurality of potential results obtainable from the component inference process, a respective probability of obtaining a respective potential result and another potential result from the plurality of potential results.

12. The apparatus of claim 11, wherein:
the machine learning process includes a classification process,
the plurality of potential results comprises a plurality of classes such that the probability information indicates, for each class of the plurality of classes obtainable from the component inference process, a second respective probability of obtaining the respective class and another class from the plurality of classes, and
the first inference result comprises, for each class i in the plurality of classes, a respective first confidence c₁(i), and the second inference result comprises, for each class i in the plurality of classes, a respective second confidence c₂(i).

13. The apparatus of claim 12, wherein the probability information comprises, for each class i in the plurality of classes, a respective conditional probability, P(i, j|j), of obtaining the respective class i and the another class j from the plurality of potential results given the another class j has been obtained from the component inference process, and wherein, when the instructions are executed by the at least one processor, the apparatus is further caused to determine the respective second confidence c₂(i) for the respective class i in the plurality of classes according to:
$${c}_{2} ( i ) = {c}_{1} ( i ) + {\sum }_{i} {c}_{1} ( j ) P ( i , j \vert j ) .$$

14. The apparatus of claim 11, wherein:
the machine learning process comprises a regression process,
the plurality of potential results comprises a plurality of values of a parameter, and
the first inference result comprises a first probability distribution P₁(xᵢ) of the parameter associated with first data i in the input and the second inference result comprises a second probability distribution P₂(xᵢ) of the parameter associated with the first data i, xᵢ being a first value of the parameter.

15. The apparatus of claim 14, wherein the probability information comprises a joint probability P(xᵢ, xⱼ) of obtaining the first value xᵢ of the parameter and obtaining a second value xⱼ of the parameter, and wherein, when the instructions are executed by the at least one processor, the apparatus is further caused to determine the second probability distribution P₂(xᵢ) according to
$${P}_{2} ( {x}_{i} ) = \int {P}_{1} ( {x}_{j} ) P ( {x}_{i} , {x}_{j} ) d {x}_{j} .$$

16. The apparatus of claim 14, wherein the probability information comprises a conditional probability P(xᵢ|xⱼ) of obtaining the first value xᵢ of the parameter given a second value xⱼ of the parameter has been obtained, and wherein, when the instructions are executed by the at least one processor, the apparatus is further caused to determine the second probability distribution P₂(xᵢ) according to:
$${P}_{2} ( {x}_{i} ) = \int {P}_{1} ( {x}_{j} ) P ( {x}_{i} \vert {x}_{j} ) d {x}_{j} .$$

17. The apparatus of claim 11, wherein, when the instructions are executed by the at least one processor, the apparatus is further caused to:
receive an indication of the probability information from the network device; and
update the probability information based on the first inference result or the second inference result.

18. A network device comprising:
at least one processor; and
a memory storing instructions which, when executed by the at least one processor, cause the network device to:
transmit, to each of a plurality of processing apparatuses, a respective first input in a plurality of first inputs, the respective first input being for a respective component inference process as part of a distributed inference process representative of a machine learning process; and
receive, from the plurality of processing apparatuses, first inference results obtained based on probability information and the plurality of first inputs, wherein the probability information indicates, for each potential result of a plurality of potential results obtainable from the respective component inference process, a respective probability of obtaining a respective potential result and another potential result from the plurality of potential results.

19. The network device of claim 18, wherein the plurality of first inputs comprises a plurality of second inputs and at least one redundant input, and wherein, when the instructions are executed by the at least one processor, the network device is further caused to:
encode the plurality of second inputs to generate the at least one redundant input; and
decode the first inference results to obtain second inference results.

20. The network device of claim 18, wherein, when the instructions are executed by the at least one processor, the network device is further caused to:
receive, from at least one of the plurality of processing apparatuses, a respective update to the probability information based on the first inference results obtained from the respective component inference process.
